(19) United States
(12) Patent Application Publication
(10) Pub. No.: US 2006/0212376 A1
(43) Pub. Date: Sep. 21, 2006

(54) Systems and methods for real-time, dynamic multi-dimensional constraint analysis of portfolios of financial instruments

(75) Inventors: David L. Snyder, Pittsford, NY (US); Jeremy M. Waterman, Webster, NY (US); Bruce M. Thompson, Rochester, NY (US); Anthony M. Vito, Sodus, NY (US); Bhaskaran Balakrishnan, Fiarport, NY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Perspective Partners, Rochester, NY (US)

(21) Appl. No.: 11/087,057

(22) Filed: Mar. 21, 2005

(51) Int. Cl. G06Q 40/00

(52) U.S. Cl. 705/35

(57) ABSTRACT

An automated method of managing or constructing a portfolio comprising at least one financial instrument defining portfolio attributes, the method using a system comprising a processor, a display and an input device. The method comprises defining at least one objective representing a desired state for the portfolio attributes and defining a set of constraints that are defined in relation to a computable, desired state of portfolio attributes in relation to the at least one objective. A constraints analysis module based upon the set of constraints is generated and provided to the processor. The portfolio is evaluated with the processor using the constraints analysis module and the state of the portfolio attributes based upon the evaluation is displayed. At least one option for altering portfolio attributes in order to more effectively meet the at least one objective is simultaneously displayed. The option is displayed with an interactive user input mechanism that allows for selection of an option and automatic evaluation and display of the state of the portfolio attributes due to selection of the option.

### CROSS-REFERENCES TO RELATED APPLICATIONS

Not Applicable

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

1. Field of Invention

This invention relates to a method and apparatus for performing real-time multi-dimensional constraint analysis of financial instruments that comprise a portfolio. More specifically it relates to a method and apparatus for providing such a mechanism in financial services to support an advisor in the often vexing problem of constructing product recommendations which have to meet multiple sets of very specific constraints. The present invention relates to integrating such a method and apparatus with a portfolio construction or investment recommendation system, yielding a recommendation that better accommodates the full range of constraints that must be considered in less time and with less effort than current methods afford.

2. Background of the Invention

Within the financial services industry, a significant proportion of human time is spent in the construction of investment portfolios, or recommendations for presentation to prospects and clients. Despite marketing claims that recommendations are constructed with engineering precision tailored to each client, it is well-known by practitioners of the trade that, even with the availability of software tools considered best-of-class from various companies, constructing a recommendation is a “time-consuming activity that is more of an art than a science.” The reason for this less than ideal situation is that, when building a recommendation, the financial advisor is performing a balancing act amongst multiple, often conflicting objectives, which, given the present state of the art is a burdensome, mentally taxing activity.

It is mistakenly assumed that investment management principles—assessing the client's goals, time horizon, risk profile and determining an appropriate asset allocation—are the sole criterion by which recommendations are made. Building a trusted relationship requires that the advisor construct a recommendation that takes into account other aspects of the client. For example, a client may have a particular aversion to a specific security, an industrial sector or even a mutual fund house. The advisor must also take into consideration other fiduciary and regulatory constraints such as the tax consequences of liquidating positions, fee structures and mutual fund management fee breakpoints.

Client-centric considerations are not the only sources of constraints facing financial advisors constructing recommendations. Institutionally imposed marketing criteria (such as having to use a “select” product shelf), sales criteria (such as making a revenue quota), and even personal criteria (such as having a set of “favorite” mutual funds) implicitly play a factor in the recommendation building activity.

Even within the limited scope of investment analytics, many portfolio construction tools fail to inform and/or guide the financial advisor regarding potential analytical conflicts inherent in a recommendation. As a simple example, it is well known in the art that portfolio diversification is a fundamental guiding principle when creating a recommendation. However, from an investment management perspective, diversification is necessary not only at the individual security level, but at a sector, and manager level. In reality—for example, given a limited product shelf—these criteria may be at conflict with one another. Creating a portfolio that contains a large cap stock and a small cap stock may provide asset class diversification, but if they belong to the same industrial sector such as Telecommunications, adequate sector diversification may not be achieved. Similarly, if an advisor were to achieve manager diversification by creating a recommendation with 2 different fund families, but the underlying holdings of each chosen fund had an overlap of 90% the manager diversification objective would be attained at the expense of security level diversification.

The underlying holdings of mutual funds or sub-accounts in variable annuities present yet another challenge in the portfolio construction process. It is common for mutual funds to invest in instruments across a range of asset classes. For example, the prospectus objective of a Domestic Large Cap mutual fund may allow the manager to invest a certain percentage in foreign equity, or hold a proportion of the fund's capital in Cash and Cash Equivalents.

Likewise, a “Balanced” fund may hold equities, bonds and cash. As an illustration, consider 2 hypothetical “Large Cap” mutual funds with the following asset allocations:

| Symbol | Name | Foreign | Large Co | Small Co | Long FI | Interim FI | Short FI | Cash | Other |
|---|---|---|---|---|---|---|---|---|---|
| ABCBX | ABC Large Co | 5.00% | 85.00% | 0.00% | 0.00% | 0.00% | 0.00% | 10.00% | 0.00% |
| DEFBX | DEF Blue Chip | 13.60% | 73.90% | 0.00% | 0.00% | 0.00% | 0.00% | 12.00% | 0.50% |

Additionally, assume, based on a client's time horizon and risk profile, the financial advisor needs to construct a $100,000 portfolio comprising the following target allocations:

| | Large | Small | Long | Interim | Short | | |
|---|---|---|---|---|---|---|---|
| Foreign | Cap | Cap | FI | FI | FI | Cash | Other |
| 7.55% | 39% | 2% | 11% | 7% | 8% | 20% | 0% |

Under this scenario the target dollar allocation to the Large Cap asset class is $39,000. However, when constructing a recommendation, the advisor must take into account the underlying asset allocations of the two funds. Simply allocating $39,000 to ABCBX will only yield a target allocation of $39,000*0.85=$33,130 to the Large cap asset class. In point of fact, it is an allocation of $45,882 to ABCBX would achieve the desired large cap target allocation. However, if the advisor was to allocate $45,882 to ABCBX, the advisor must take into account that 10% of this amount, $4588.20, contributes to the Cash portion of the overall asset allocation, which would then be ($100,000*0.20)−$4588.20=$15,411.8. Thus, the advisor is constantly challenged to maintain portfolio level asset allocation targets even when he is working on a single investment.

It should be appreciated that in actual practice, the constraint analysis problem described above is greatly amplified and very often multi-dimensional. For example, it is normal to find a product shelf with more than two mutual funds for a particular asset class. As mentioned previously, asset allocation attributes are not the sole analytical attributes of a recommendation. Additionally, it is often the case that the financial advisor first needs to liquidate some instruments in an existing portfolio before creating a recommended portfolio. Determining an appropriate liquidation strategy needs to take into several factors such as cost basis, surrender charges, client's investment vehicle preferences, etc. Likewise, recommendation decisions on the “buy” side are not limited to purely asset allocation constraint analysis. The advisor needs to evaluate exchanges within the same fund family, mutual fund fee breakpoints, share classes, etc. Each of these considerations need to be balanced not merely one against one another, but simultaneously against all others.

Numerous other categories of constraints often need to be considered by an advisor during the recommendation construction process, such as alpha, beta, risk factors, and even whether or not a portfolio will generate adequate income to meet a cash flow need. Income sufficiency and portfolio longevity constraints are of special importance given the growing numbers of retired persons and the increase in average life expectancy. These constraints are inherently at conflict with each other—longevity objectives typically require more “aggressive” asset allocation and/or increased risk, while meeting income considerations would suggest a more “conservative” strategy. When added to the previously mentioned investment management constraints such as investment and manager diversification and client specific constraints such as tax implications of investment liquidation, we are presented with a realistic picture of the challenges the financial advisor faces when building a recommendation.

Clearly then, it would be beneficial for the advisor to be informed how addressing one constraint potentially impacts the other constraints. Furthermore, if this information were to be provided to the advisor in real-time synchrony with the steps of construction themselves, it would provide an enormous time-saving benefit to the recommendation construction process, and would facilitate a result that minimizes violations of those constraints which might have negative impact on the overall quality and appropriateness of a portfolio recommendation.

Many financial advisor tools provide some element of functionality and content to support the recommendation construction process. However, no attention has been paid to facilitating the multi-dimensional constraint analysis inherent in the recommendation creation activity. More specifically, currently no enabling technology exists that is able to incorporate the full spectrum of constraints the advisor has to address when a recommendation is being constructed and, especially, may pro-actively guide, in real-time, the portfolio construction activity.

The utility of the present invention may also be appreciated in relation to prior art financial advisory software packages which separate portfolio construction activities and portfolio analytic activities are two separate and discrete user work-flows. Using these systems, the financial advisor normally has to create a portfolio in its entirety and then as a discrete step, perform analytics on the portfolio to ensure that it meets any specified objectives. Unlike these systems, the present invention provides ‘in place’ real-time analytical feedback that allows the user to incrementally create a portfolio and at all times during the process, be made aware of the analytical characteristics of the recommendation being constructed, and of the implications of each incremental buy/sell step taken as part of the creation process. It will be obvious that the disclosed method delivers significant time-savings as well as qualitatively better recommendations.

It should be appreciated that a method to provide the multi-constraint analysis at the point of an investment sale discussed above provides additional benefits to the current financial services work-practice and to the ultimate consumers of financial products and services, i.e., individuals who are faced with making investment decisions with significant economic consequences.

Firstly, Compliance procedures—ensuring that sales activities conform to fiduciary and regulatory rules—in financial services firms are increasingly coming under scrutiny for their lack of effectiveness in intercepting inappropriate investment sales before rather than after the fact. Clearly, capturing a recommendation and the state of the multiple constraints at the point it was constructed would significantly enhance existing Compliance capabilities.

Another aspect of the financial services work-practice that the present invention addresses relates to client communications and disclosure. Many planning and investment management work-flow systems allow the financial advisor to generate a recommendation to the client in the form of a report or presentation. However, since these systems do not support multi-dimensional constraint analysis integrated into the recommendation creation process, they are incapable of disclosing potential conflicts in analytical and other constraints. Clearly a system that is capable of disclosing the trade-offs the advisor had in constructing recommendation will allow a client to make more informed decisions regarding their investment strategy.

In view of the foregoing, what is needed is an integrated system that provides:

1. A method to specify and store the multiplicity of constraints that impact the creation of a recommendation.

2. A pro-active, “constraint-aware” means for the user to construct a recommendation, one that is affected by multiple, often conflicting constraints.

3. A method to provide decision support at the point of portfolio construction whereby the user may observe the nature and magnitude of constraint violations, individually and in relation to one another and to be informed in real-time how addressing one constraint impacts others.

4. A method to provide intelligent and pro-active guidance to the recommendation construction process, one which takes into account the existing state of the recommendation in relation to the constraints.

5. A method to capture the final recommendation and the context under which the recommendation was created, specifically in relation to the multiple objectives the recommendation being created is attempting to address for the purposes of proactively monitoring recommendations against compliance violations, as well as to allow clients to make more informed investment decisions by the inclusion of the multi-constraint analysis in client communications.

Finally, it should be obvious that the disclosed invention need not be used merely in the creation of an investment recommendation by a financial advisor, but in any work flow that entails the creation of financial products that are subject to a plurality of objectives. Such activities may include the creation of a mutual fund manager's portfolio, a personalized mortgage and the like.

### BRIEF SUMMARY OF THE INVENTION

The present invention integrates the real-time feedback of multi-dimensional constraint analysis into the portfolio construction process within the framework of a financial advisory [software] system. Non-limiting examples of constraints and criteria are: Investment management or analytical constraints, client specific constraints, sales criteria, marketing criteria and legal criteria.

According to one aspect of the present invention, the multi-dimensional constraint analyzer includes a programmable rules engine that performs conformity checks against a plurality of parameter values. A constraint rule is a conditional expression of a specified ideal value, or range, against which the data values representative of characteristics or attributes of an instrument or set of instruments are evaluated. The result of the evaluation indicates a measure of deviation from the ideal. The degree of departure from the ideal may be absolute (binary) or on a graded scale, such that the constraint can be said to be either satisfied or violated, in whole or to a certain degree. The rules are stored either in computer memory, or on disk/databases. The constraint rules engine is linked to data repositories which are required to support the evaluation of the individual constraints. These include: a product database, a market database, allocation models database, analytical data, user access control list etc.

According to one aspect of the present invention, the multi-dimensional constraint module is made accessible to end-users such as financial advisors by means of a portfolio construction module and a user-interface which provides a) input mechanisms to add and remove instruments b) input mechanisms to manipulate position amounts and other attributes of the instruments and c) a real-time feedback mechanism that indicates to the user the impact of changes being made to the recommendation along all the configured criteria. According to one aspect of the present invention, multi-dimensional constraint analysis may be in whole or in part be executed by the client machine.

According to one aspect of the present invention, the user commences the portfolio construction process with an initial recommendation [screen] based on a system-performed multi-dimensional constraint analysis. In one embodiment, the initial constraint analysis performed includes a pre-selection of financial products to be used for the eventual recommendation based on product selection criterion stored in the constraint analysis rules engine. Exemplary rules that are applied include: advisor licensing status, client risk tolerance, client time horizon and tax sensitivity status. The constraint analysis returns the constrained product shelf list to the portfolio recommendation service, which in turn populates the information in the user interface screen by means of user-interface elements such as drop-down boxes.

From this initial state, the user, with the aid of ergonomically designed user-interface controls such as drop down boxes, text-field boxes, radio buttons, etc., iteratively adds or deletes individual investments to a working recommendation. Associated with every investment are a set of parameters which the user is able to manipulate. In one embodiment the parameters that the user may manipulate include one or a combination of total position percentage, absolute dollar amount, number of shares, or asset allocation percentages.

For any change that the user makes to any input field or parameter, the constraint analyzer computes in real-time the consequence of the change to the underlying set of constraints. The outcome of the computations is presented in a status area and visually informs the user of the impact of the latest change. Furthermore, based on the outcome, the analyzer may proactively limit the user's choice of input elements in order to expedite the portfolio construction activity. For example, if the current portfolio has satisfied the recommended Large Cap allocation percentage, other Large Cap investments in the product shelf drop-downs are filtered out.

According to another aspect of the present invention, the final investment recommendation, that is, the state of the recommendation when the user exits the portfolio recommendation user-interface, and the corresponding multi-dimensional constraint state are stored in a constraint analysis data repository. This data is accessible to other system modules such as a Report Generation module output generator that may be configured to present graphically and/or textually some or all aspects of the multi-dimensional constraint analysis. Examples of outputs include: an Analytical Checklist, a Disclosure statement, etc. The format of this output may be electronic or “print ready”.

According to another aspect of the invention, working recommendations may be stored in an “in progress” data repository and retrieved for further modification activities. According to another aspect of the invention, “in progress” recommendations are run against the multi-constraint analysis when loaded into the portfolio construction module by the user. In this manner, the user may be notified of any changes to criteria that may have occurred since the last time the user was working on the recommendation. As an example, the system may flag a mutual fund used in the recommendation that has come under SEC investigation.

In one embodiment of the present invention, the constructed recommendation and the corresponding constraints results state are made available to enhance a Compliance work-flow that may monitor investment recommendations. The Investment recommendation monitoring modules allows the Compliance officer to review all recommendations and the corresponding constraints results set in the form of pre-set screens and/or reports. In another embodiment of the present invention, constructed recommendations that violate pre-set compliance rules are flagged and alerts are proactively sent to the specified entity (e.g., Compliance department or individual).

Thus, the present invention provides an automated method of managing or constructing a portfolio comprising at least one financial instrument defining portfolio attributes, the method using a system comprising a processor, a display and an input device. The method comprises defining at least one objective representing a desired state for the portfolio attributes and defining a set of constraints that are defined in relation to a computable, desired state of portfolio attributes in relation to the at least one objective. A constraints analysis module based upon the set of constraints is generated and provided to the processor. The portfolio is evaluated with the processor using the constraints analysis module and the state of the portfolio attributes based upon the evaluation is displayed. At least one option for altering portfolio attributes in order to more effectively meet at least one objective is simultaneously displayed. The option is displayed with an interactive user input mechanism that allows for selection of an option and automatic evaluation and display of the state of the portfolio attributes due to selection of the option.

The present invention also provides a system for managing or constructing a portfolio comprising at least one financial instrument defining portfolio attributes, where the system comprises a processor, a display in communication with the processor, and an input device in communication with the processor. The system further comprises a constraints analysis module based upon a set of constraints that are defined in relation to a computable, desired state of portfolio attributes in relation to at least one objective representing a desired state for the portfolio attributes, and at least one indicator viewable on the display that indicates the state of at least one portfolio attribute relative to a constraint attribute. An interactive input mechanism adjacent to an indicator on the display is provided that allows for manipulation of a specific financial instrument and related attribute information in order to alter portfolio attributes. The processor automatically updates the indicator and the interactive input mechanism in response to any manipulation of the specific financial instrument and any manipulation of the attribute information.

Other features and advantages of the present invention will be apparent upon review of the following detailed description of preferred exemplary embodiments.

### BRIEF DESCRIPTION OF THE DRAWINGS

FIG. 1 is a schematic of computer system architecture;

FIG. 2 is a block diagram of financial advisory system;

FIG. 3 is a schematic illustrating one embodiment of a multi-dimensional constraint analyzer in accordance with the present invention;

FIG. 4A illustrates pseudo-code of exemplary constraint specification;

FIG. 4B is a table describing evaluation of recommendation states;

FIG. 5 is a flow-chart of real-time multi-dimensional constraint module;

FIG. 6 is a flow-chart of user work-flow associated with portfolio construction;

FIG. 7 illustrates a portfolio construction user-interface with real-time multi-dimensional constraint analysis status indicators in accordance with the present invention;

FIG. 8A illustrates a portfolio construction user-interface with real-time multi-dimensional constraint analysis status indicators in accordance with the present invention;

FIG. 8B illustrates a portfolio construction user-interface with real-time multi-dimensional constraint analysis status indicators in accordance with the present invention;

FIG. 8C illustrates a portfolio construction user-interface with real-time multi-dimensional constraint analysis status indicators in accordance with the present invention;

FIG. 8D illustrates a portfolio construction user-interface with exemplary investment selection mechanism in accordance with the present invention;

FIG. 9A illustrates an exemplary real-time multi-dimensional constraint analysis status indicator in accordance with the present invention;

FIG. 9B illustrates an exemplary real-time multi-dimensional constraint analysis status indicator in accordance with the present invention;

FIG. 9C illustrates an exemplary real-time multi-dimensional status indicator and input controls in accordance with the present invention;

FIG. 9D illustrates an exemplary real-time multi-dimensional status indicator and input controls in accordance with the present invention;

FIG. 9E illustrates an exemplary real-time multi-dimensional status indicator and input controls in accordance with the present invention;

FIG. 10 is a flow diagram of a method to pro-actively guide recommendation construction in accordance with the present invention;

FIG. 11 is an exemplary real-time display of multi-dimensional constraints and proactive guidance in accordance with the present invention;

FIG. 12 is a flow-chart for integrating recommendations and M-CA status into investment sales monitoring sub-system in accordance with the present invention;

FIG. 13 illustrates an exemplary recommendations monitoring user interface in accordance with the present invention; and

FIG. 14 illustrates an exemplary client communication with multi-dimensional constraint in accordance with the present invention.

### DETAILED DESCRIPTION OF THE INVENTION

Definitions:

User: Financial Advisor who is building an investment recommendation

Investment: A security or financial instrument such as, for example, a stock, a bond and a mutual fund, and its value, expressed in either a currency or as a proportion of a portfolio's total value

Portfolio: A set of investments and their monetary values, the portfolio may include only a single investment, and may only include an amount of cash

Client: The person for whom the financial advisor/user is building a recommendation

Client portfolio: The original portfolio provided by the Client to the user.

Working portfolio or working solution: Intermediate set of investments that are used by the user to construct a recommendation.

Recommendation: The (final) set of investments presented to the client as an alternative to the client's current portfolio

Packaged Solution: A pre-built portfolio that may be loaded by the user into the recommendation workbench and that may be used to jump-start/seed the recommendation.

Exemplary Computer System Architecture

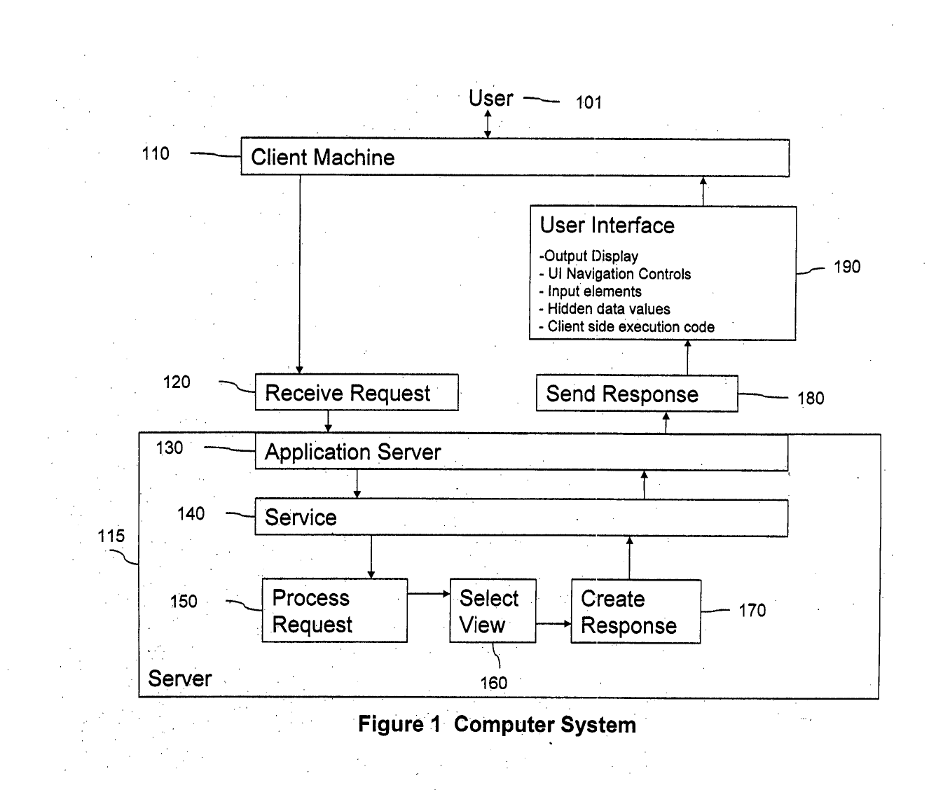

FIG. 1 is a schematic of a client-server system architecture 100 modeled on the standard Model-View-Controller design paradigm. A user 101 at a client machine 110 operates and interacts with a user-interface 190 to perform a work activity. User-interface 190 may be a conventional web browser application, or standalone “rich client”, or standalone single-user application. There may be a plurality of client machines and thus end-users connected over a network to a host server 115 or servers which are configured to implement a network accessible computerized application such as a financial advisory system described below.

A user at a client side machine accesses the host system and issues a request in a conventional manner. For example, for a web-based user interface, the user enters a URL, or chooses a previously stored book-mark. For a standalone application the user may “double click” an icon on the client desktop. The client software component on the end-user's machine communicates with the server using standard transmission protocols such as HTTP, HTTPS, SOAP, etc.

The host server machine contains an application server 130 that provides a gateway to one or more network accessible applications. Each application may contain several software components or services that together provide the necessary functionality for the end-user application. Data may be shared across services and across user sessions by means of memory caches and database technologies.

The typical time-sequenced order of events in this software architecture paradigm is as follows: The application server 130 receives a request 120 from the client machine 110. The application server parses the request and determines the appropriate Service 140 to be invoked. Service 140 performs step Process Request 150, which in effect applies the business logic associated with the request. Based on the outcome of the processing, the Select View component 160 decides the appropriate information to be returned to the client. Step Create Response 170 in turn populates a user-interface template to create the appropriately formatted data to be sent to the client. Step Send Response 180 transmits the data back to the software client according to the established transmission protocol. The client machine renders the received user-interface data in a conventional manner, such as the active browser window. In general terms, the transmitted user-interface page 190 may contain output elements (such as instructions, text labels, graphical displays), navigational elements (such as a Help, Next, Previous buttons and hypertext links), input elements (such as text fields, drop-down boxes, select boxes, radio buttons), hidden data values and client-side execution code such as JavaScript and formatting style directives.

Exemplary Financial Advisory System

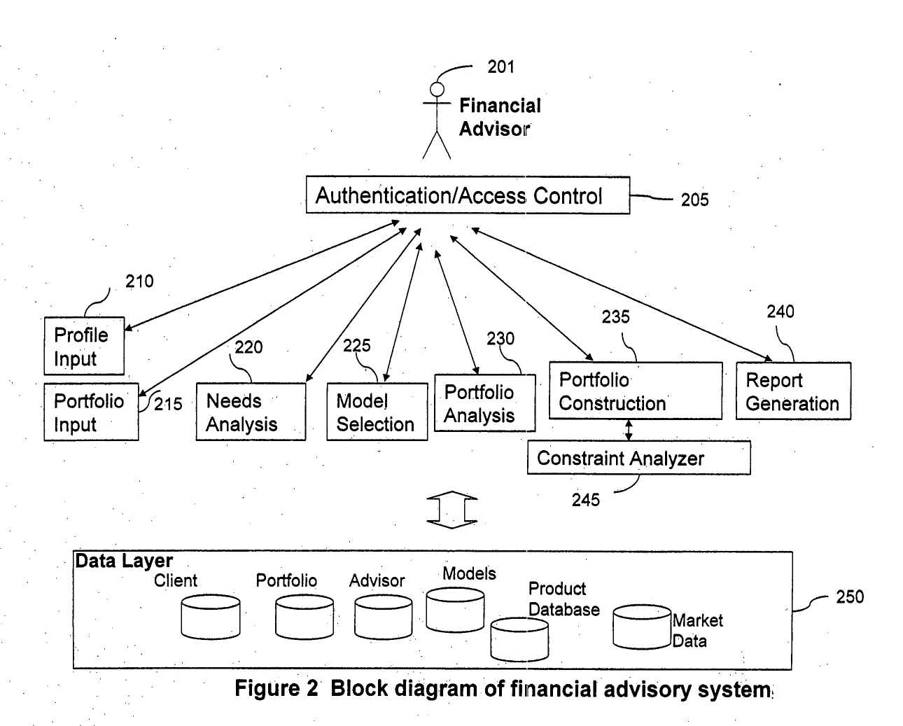

FIG. 2 is a block diagram of an exemplary Financial Advisory System (200) built in accordance with the computer architecture 100 described. According to the embodiment depicted, during the course of making a recommendation for the eventual presentation to the client, a financial advisor 201 performs several discrete activities each of which are supported by a corresponding software service or module 140 as described in the previous section. These activities include inputting a client's personal information/profile 210, inputting a client portfolio 215, analyzing the client's needs including future income requirements 220, selecting an appropriate model 225, analyzing the client's portfolio 230, constructing a recommended portfolio for the client 235 and preparing a report (either electronic or hardcopy) for presentation to the client 240. Access to these exemplary services is provided through a configurable authentication/access control module 205.

The software services that support these activities access data repositories representing various entities in the Data Layer 250. These repositories may include end-user/financial advisor data, client data, client portfolio data, asset allocation models, product data, market data and the like. Each repository contains the attributes of the entities necessary for the system to support its end-user activities. For example, the Client data repository may contain the client's personal and contact information. Similarly, the market data repository may contain investments and analytical attributes such as investment type and specific attributes of each investment type such as market capitalization values for all equities. It is common for these repositories to be stored in relational database tables that provide efficient access to the service modules. For example, data may be stored in such a manner that a financial advisor is associated with all his clients who are in turn associated with all their portfolios.

An end-user such as a financial advisor interacts with the financial advisory system by means of a user interface that provides access to these exemplary services. Appropriate navigational links in the user interface allow the user to perform tasks sequentially (for example, following a well-defined work flow) or access various services according to a specific task. The financial advisory system also allows a user to perform activities over time by storing data across user sessions. For example, the financial advisor may create a client record and client profile parameters at a point in time and later perform a portfolio analysis for this client without having to re-key previously entered client data.

In an exemplary embodiment of the present invention, the multi-dimensional constraint analyzer 245 is a software component that is integrated with the Process Request component 150 within the portfolio construction service 230. Thus, from an end-user perspective, the constraint analyzer may be seamlessly integrated into the portfolio construction activity.

Exemplary Multi-Dimensional Constraint Analyzer

In general terms, the multi-dimensional constraint analyzer is a software module that evaluates the characteristics of an input state against a solution characterized by a desired set of objectives which in turn are defined by a multiplicity of criteria or constraints. For example, in the design of a coffee cup, two examples of objectives may be structural integrity and low thermal loss where the criterion for measurement are ‘drop height’ and ‘compressive load’ respectively.

Within the field of financial services examples of desired objectives for an investment recommendation may be: security diversification, asset class diversification, manager diversification, income generation and portfolio risk. The criterion for security diversification may be specified as the number of individual investments in a portfolio. Likewise, the criterion for asset class diversification may be a percentage allocation to each asset class.

The input state is a set of attributes and their (point-in-time) values measured in the same dimensionality as the criteria that define the objectives. Input attribute values may influence more than one objective, and when this is so, the impact could be either positive or negative. A positive impact is one where the current value of an attribute moves all impacted objectives towards their desired state. Conversely, a negative impact is one where the current value of an attribute moves one objective closer to its desired state, but farther away from the desired state of the other objectives. For example, adding a mutual fund to an investment recommendation with the objective of increasing manager diversification (desirable) would be a positive influence on asset class diversification if there were no significant holdings overlap between the existing recommendation and the newly added mutual fund, and there was not an unintended consequence of over diversification by dint of having too many underlying holdings. As described in a prior section, the multiplicity of objectives imposed upon the portfolio construction activity goes beyond purely analytical constraints, and may include constraints and criteria required to meet other objectives such as sales objectives, marketing objectives and legal objectives.

Constraints and criteria by which objectives are to be assessed or evaluated by the multi-dimensional constraint module specified as computable evaluation rules which may include standard operators such as equality, less than, greater than, not equal to, etc. A single objective may also comprise more than one evaluation rule conjoined by logical operators AND, OR, NOT, etc. Furthermore, objectives may be configured with ‘hard’ constraints where the satisfaction of the constraint is deemed necessary for the overall solution to have been achieved, or with ‘soft’ constraints—the violation of which does not invalidate the overall solution.

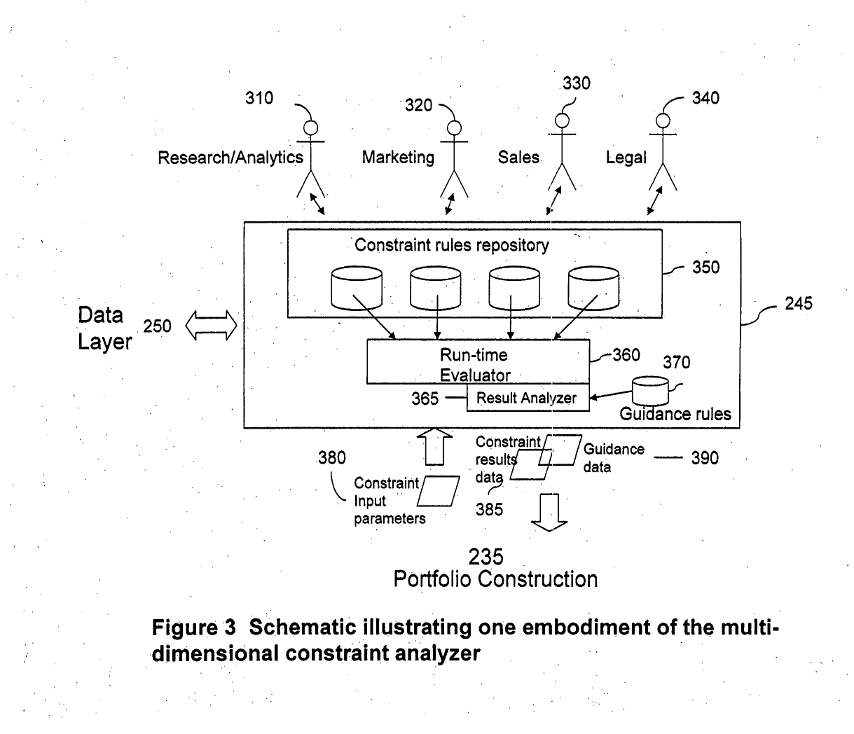

FIG. 3 is a schematic illustrating a representative multi-dimensional constraint analyzer 245 in accordance with a preferred embodiment. As discussed in a previous section, the constraint analyzer is integrated with the portfolio construction service 230 and the data layer 250 of the exemplary financial advisory system. Portfolio construction service 230 delivers inputs for evaluation and accepts the evaluation and other outputs from the constraint analyzer. The constraint analyzer may connect to data repositories in data layer 250 for both input and output operations. For example, the constraint analyzer may access a market data repository containing attributes of investments being analyzed. Likewise, the constraint analyzer may store data into the Data Layer, such as, for instance, the final state of the constraint analysis after a recommendation has been created.

In a preferred embodiment, the constraint analyzer may comprise 3 distinct sub-systems—the Constraint rules repository 350, Run-time evaluator 360 and Result Analyzer 365. Constraint rules repository 350 contains objectives and the constraint rules that define the objectives to be met. Furthermore, the constraint rules may be grouped according to configured grouping criteria. In one embodiment, the grouping may be according to institutional or functional ownership, such as Research, Sales, Marketing, Fiduciary and Legal. The constraint rules repository may support maintenance activities such as the adding, deleting and updating of constraints. According to another embodiment, the maintenance function for the constraint rules repository may be integrated with access control service 205 to support appropriate authentication and access.

Run-time evaluator 360 accepts input parameter values 380 from an external service such as the portfolio construction service 235 and performs an evaluation of the inputs against the plurality of configured constraints in the constraints rules repository 250 to determine whether the associated objectives have been met. In general, the output of the run-time evaluator, i.e., the constraints results data 380, contains the status of the multi-constraint analysis in response to the supplied inputs. The constraints results data consists of a result set where each entry in the result set may contain data or reference to an objective, an indicator of success, and a measure of deviation from a target (or, success point).

Results Analyzer 365 performs an analysis of constraints results data with the purpose of providing pro-active guidance to the multi-constraint results data. Guidance rules repository 370 stores the logic that may be used to evaluate the constraint results set, and provides multi-constraint analysis solution directives. This functionality is further elaborated upon herein in the subsequent section entitled: Exemplary Pro-active Guidance

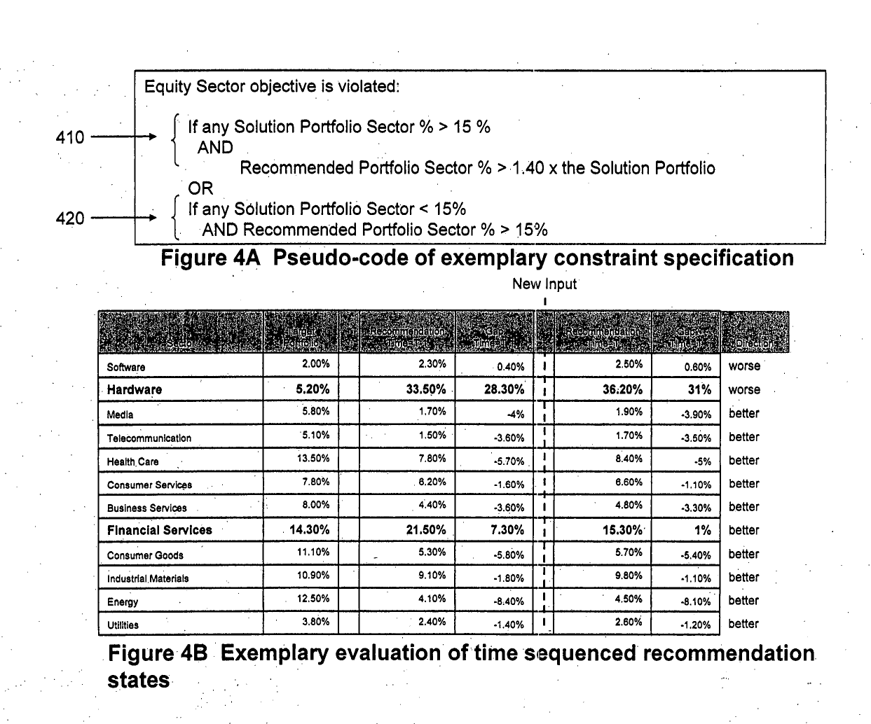

FIG. 4A is an illustration of one objective and the expressive richness of a constraint rule that be stored in constraint rules repository 350. The specific objective illustrated is Equity Sector diversification, which in broad terms is an appropriate allocation of the equity component of a recommendation across a set of industrial sectors. In one embodiment, the appropriate or target equity sector allocations are specified by means of client suitability based model portfolios. The target allocations for each model may be stored in the Data Repository 250 and may be updated periodically to reflect changing market conditions. Alternatively, the model may be specified by the end-user using the portfolio construction user-interface.

According to the exemplary pseudo-code illustrated, the equity sector objective is violated when one of two constraint rules evaluate to true. Pseudo-code section 410 specifies that an over-allocated sector is flagged if its allocation in the solution portfolio sector percentage is greater than 15% and the corresponding sector allocation in the recommended portfolio is greater than 140% of the recommended allocation. As an example, if the target allocation for ‘Software’ is 20% and the corresponding allocation in the recommendation is 30% then 410 would evaluate to true, and the Equity sector constraint violation would have occurred.

Similarly, pseudo-code section 420 specifies that an over-allocated sector is to be flagged if the allocation in the model is less than 15% and the allocation in the current recommendation is greater than 15%. As an example, if the ‘Hardware’ allocation target were 10% and the allocation percentage of ‘Hardware’ in the recommendation were 20%.

While the preceding discussion describes a constraint rule and its evaluation for a single objective, it should be clear that the constraint analyzer may support the evaluation of a plurality of objectives that in concert define an ideal state. These objectives may contain hard or soft constraints. For instance, the constraint rules repository may contain a ‘soft’ sales objective for a specific mutual fund family. When configured with such an objective, the run-time evaluator may compute the dollar value of the recommendation allocated to the target mutual fund family and determine the progress towards the sales objective.

In addition to performing a point-in-time evaluation of a recommendation against the plurality of constraint rules, the constraint analyzer may also be configured to perform a comparative static analysis of two time-sequenced recommendation states with the purpose of providing an overall assessment of the consequence of the most recent changes in relation to the satisfaction of one or more constraints.

FIG. 4B is a table that illustrates the evaluative characteristic of the constraint analyzer in relation to the Equity sector objective discussed above using hypothetical data. The first two columns of the table list the configured equity sectors and target allocation percentages. For example, the target allocation to the ‘Software’ sector is 2%, the target allocation to the ‘Hardware’ sector is 5.20% and so on. The numbers in the 3rd column labeled ‘Recommendation Time=T−1’ are the corresponding equity sector allocation percentages of the “being constructed recommendation” at this specific time interval. It is easy to verify that based on these hypothetical numbers, the highlighted sectors Hardware and Financial Services violate the logic contained in pseudo-code 4A. A measure of the deviation between the recommendation and target allocation values is listed in the ‘Gap Time=T−1’ column. In this illustration, the deviation is measured as a simple signed difference between the recommendation allocation percentage and the target allocation percentage. The numbers in columns marked Time=T reflect equity sector allocation percentages of a new recommendation, presumably as a result of the user making changes to the recommendation. The associated ‘Gap’ measure, computed in the same manner as for Time=T−1 is also presented. The last column labeled is an evaluation of the recommendation at Time=T and Time=T−1 and is based on comparing individual sector allocations to the target allocations. For example, the Hardware allocation percentage is 36.20%, which compared to Time=T−1 is further away from the target allocation percent of 5.20%. In comparison, the Financial Services allocation percentage is 15.30%, which when compared to the allocation percent at Time=T−1 is nearer to the target of 14.30%. A similar evaluation may be performed against the equity sectors that do not violate the constraint 4A. Taken in its entirety, this data may be used to indicate the overall effectiveness of a change to the recommendation for a specific objective.

While the explication of the comparative static evaluation has been limited to a single objective, it should be clear that a similar methodology may be applied to other configured objectives in the constraints repository.

Flow-Chart of Real-Time Multi-Dimensional Constraint Module in Portfolio Construction

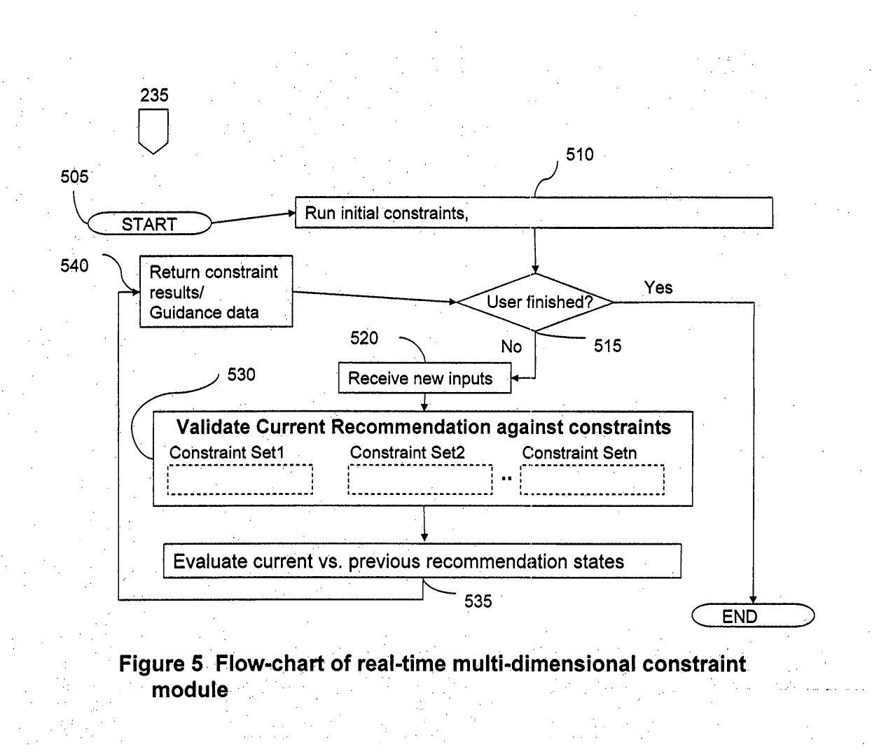

FIG. 5 is a flow diagram illustrating one embodiment by which a portfolio construction module may be integrated with a real-time multi-dimensional constraint module. At step START 505, the user accesses the portfolio construction service 235 from the user interface, which in turn, invokes the multi-dimensional constraint analyzer 245. At step 510, the constraint analyzer receives data values from the portfolio construction service. In general, the data elements represent the universe of elements required to perform the configured rules in the multi-dimensional constraint analyzer module. The data supplied to the constraint analyzer module includes: client data, client portfolio data, client suitability information and user access control data.

Step 515 is a real-time decision point for the multi-dimensional constraint module to determine if the user has signaled a stop to the portfolio construction activity. Should the user have signaled a stop, such as by pressing the “Next Step” button on the user (described below), the portfolio construction service instructs the constraint analyzer to perform a software commit/save operation which may include steps such as releasing software memory, removing temporary disk files used, etc. Alternatively, if the user is still within the portfolio construction activity, process step 520 receives the latest changes made to the recommendation and transmits the data to Step 530. At step 530 the current recommendation is validated against the configured constraint rules. At Step 535, an evaluation is performed between the previous state of the recommendation and the latest recommendation. The purpose of this evaluation is to determine a measure of ‘goodness’ of the current state of the recommendation in relation to the previous state along all the configured constraints. The resultant evaluation forms the basis of guidance data that may be presented to the user in the user interface. At step 540, the constraint analyzer returns data elements back to the portfolio construction service 235 for the purposes of redisplaying the current state of the constraint analysis. In one embodiment, the output includes guidance directives to limit user choices such as the removal of specific products from the user selection box. The guidance mechanism is described in further detail herein in the section Exemplary Pro-active Guidance.

Exemplary Portfolio Construction User Work-Flow

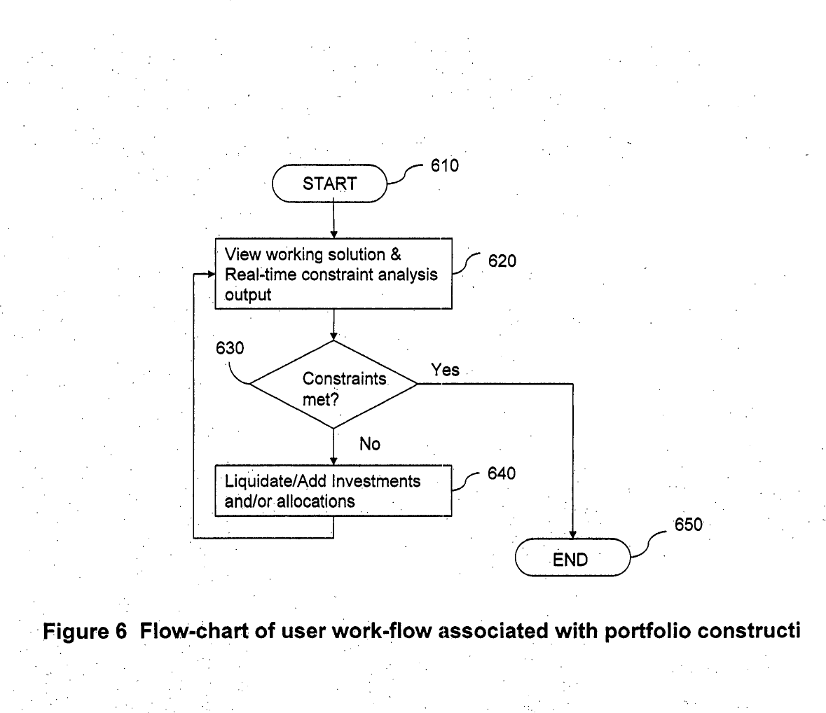

FIG. 6 is a flow diagram illustrating a method that supports an exemplary streamlined user work-flow associated with the portfolio construction module that is integrated with the real-time multi-constraint analyzer module.

At the START 610, the user views the initial state of the recommendation and the output of the multi-constraint analyzer. Step 630 is user decision point. If the state of the recommendation does not meet the configured constraints, the user at step 640 makes modifications to the working recommendation using a variety of input and/or import mechanisms. In one embodiment, the modifications include importing a pre-packaged solution, liquidating investments, adding investments by using intelligent input controls or searching for specific products and modifying allocation of investments. Any modification that is made by the user to the recommendation is captured and transmitted to the real-time constraint analyzer module which executes step 520, 530 and 540 described in the previous section. At step 620, the user now views the updated outputs of the real-time constraint analysis. This iterative process of making a modification and viewing in real-time the impact on the multiplicity of constraints is performed until the constraints are met to the user's satisfaction (the YES branch of Step 630). When this condition is reached, the user exits the portfolio construction activity (Step 515) and navigates to another component of the system work-flow. In one embodiment, the subsequent work-flow component supports a review of the finalized recommendation.

The portfolio construction user work-flow comprising steps 620, 630 and 640 are more fully appreciated in relation to the embodiments of the user-interface, and are described in further detail herein in the following subsequent sections.

Exemplary Portfolio Construction User-Interface with Multi-Dimensional Constraint Analysis Output

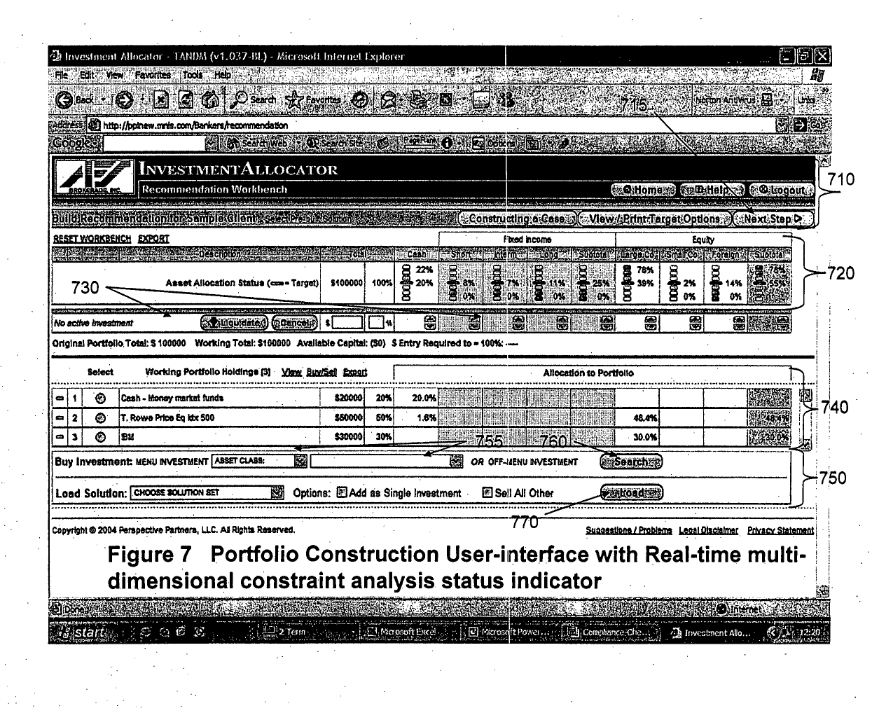

FIG. 7 depicts a screen-shot of an exemplary portfolio construction user interface in which the real-time constraint analyzer may be incorporated. The user interface attempts to help the user determine a portfolio recommendation that conforms to a multiplicity of configured constraints. According to one embodiment, the user interface helps the user construct this recommendation by displaying in real-time the state of the constraints in relation to the recommendation and providing visual indicators as to the magnitude of the violations. According to another aspect of the invention, the user interface provides mechanisms to the user to directly manipulate attributes of an investment in order to satisfy the imposed upon constraints. In an exemplary embodiment, the user navigates to the portfolio construction screen after performing the portfolio analysis step 230 on the client's current portfolio.

In general, the portfolio construction user-interface comprises:

1. Navigational elements 710 that allow the user to navigate into (610), and out of the recommendation construction activity (620). The navigational elements may support temporary departure points from the portfolio construction activity such as context sensitive help files, or a permanent departure. The “Next Step” button 715 is intended to provide for the user a mechanism to inform the system that the portfolio construction activity is concluded (Step 515).

2. A real-time constraint analysis indicator area 720 which displays the state of solution in relation to the multiplicity of configured constraints of a currently selected objective.

3. A working investment area 730 which allows the user to focus on a specific investment within the being constructed recommendation and directly manipulate its attributes.

4. A working portfolio area 740 that displays the list of investments that makes up the recommendation and their corresponding contributions to the current objective being addressed. In the illustration depicted, the objective is a target asset allocation. For example, with reference to the investment T. Rowe Price Equity Index 500, the user is able to see that this investment with a dollar allocation of $50,000 comprises 50% of the current recommendation, and furthermore it's contribution to the asset classes is 1.6% Cash, 48.4% Large Cap and 48.4% to Equity. Alternatively, if the user were solving an Equity Sector objective, the information displayed would be the contribution of this investment across the various configured equity sectors.

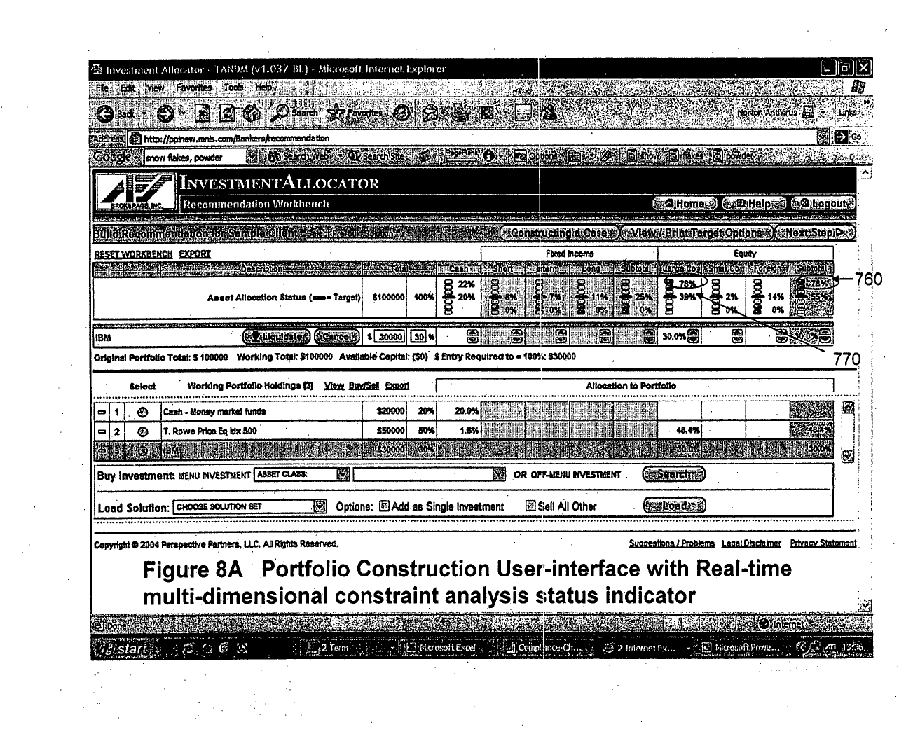

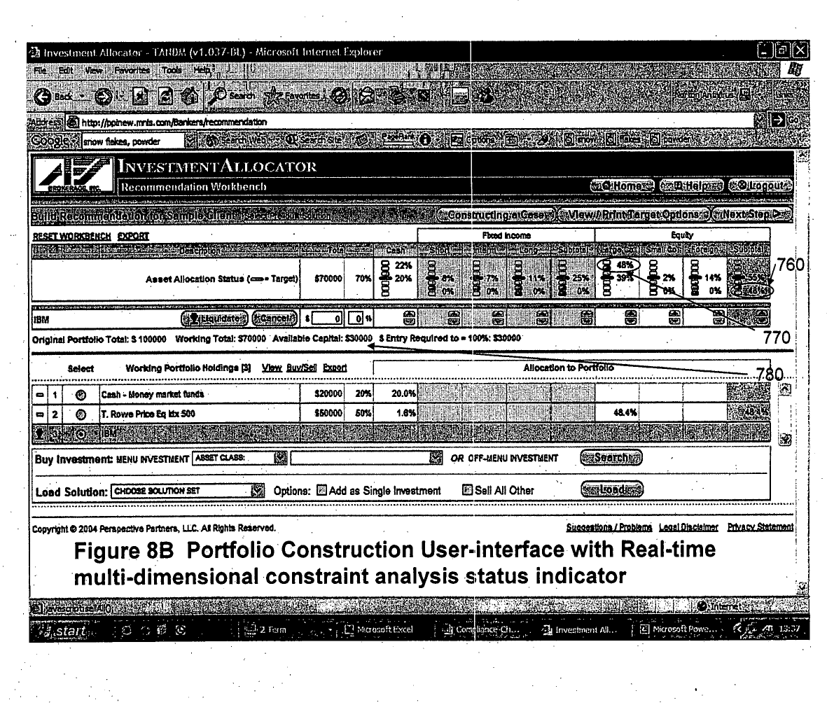

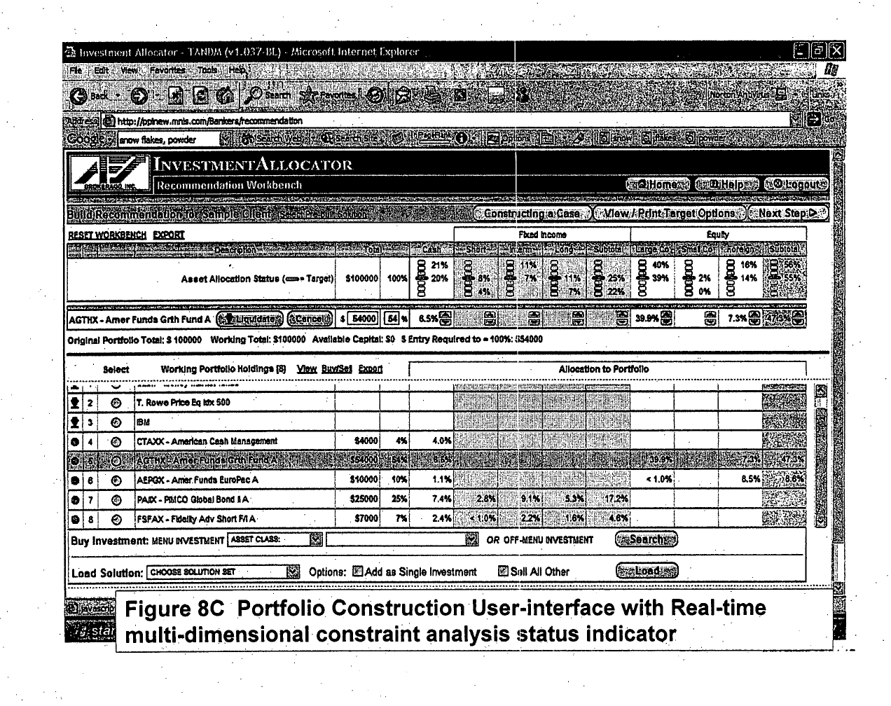

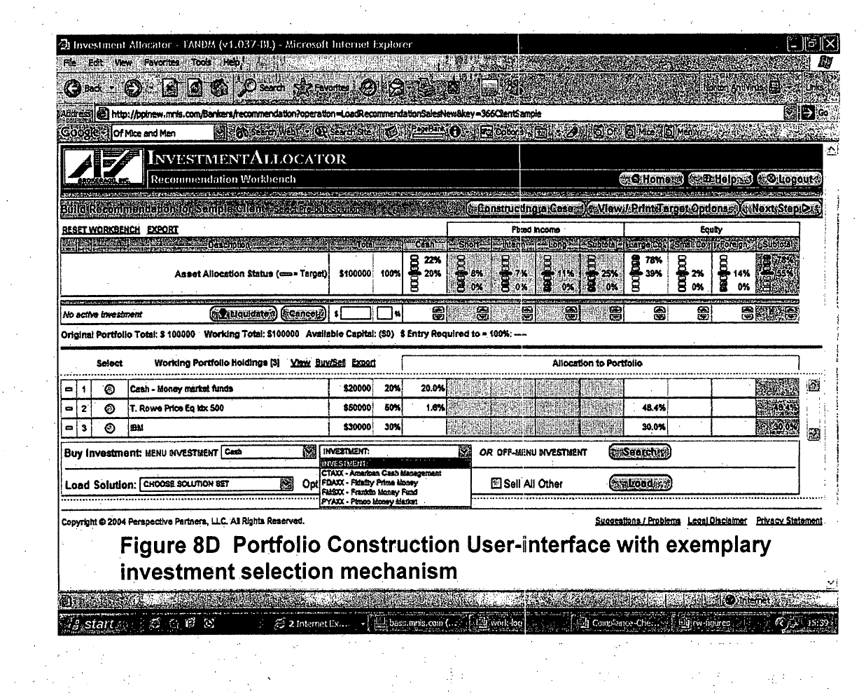

5. Investment input area 750 that enables the user to modify the recommendation by means of adding or loading investments. The user may add an investment by selecting from a list of system selected investments, or search for an investment from a product shelf repository that resides in the data layer 250. According to the illustration, selection of an investment is performed by means of a drop down boxes 755. According to one embodiment of the present invention, the drop boxes are constructed to provide a navigational path down a attribute hierarchy. In the embodiment depicted, the first drop down box lists the various asset classes. When a user selects a specific asset class, the user-interface populates the second drop-down box with investments that are bucketed in or assigned to the specified asset class. FIG. 8D is a screen shot of the user interface depicted in FIG. 7 which illustrates the drop-down mechanism described. Here the user has chosen the asset class ‘Cash’ and the second drop down box contains a list of investments that belong to this asset class. The real time constraint analyzer may apply additional rules in populating the drop-down boxes. This is described in detail below. Button 760 allows the user with access to this functionality the ability to conduct a search of the product database. The search may be specified by any supported indexed mechanisms, including by description, by identifier (such as ticker or CUSIP), by fund family, etc. The user views the search results and is able to select the specific investment to be included into the recommendation. Alternatively, the user may load a pre-built recommended portfolio for direct use or as an exemplar for further refinement. According to the illustration depicted this functionality is provided through the “Load Solution” area and button 770.

In the embodiment depicted, when the portfolio construction is first invoked by the user, the initial working solution portfolio populated in area 740 comprises the client's original portfolio. In the specific instance depicted, the working solution comprises 3 investments, totaling $100,000. The real-time constraint analysis area 720 initially displays the asset allocation of the working solution in relation to a target or ideal allocation, as determined previously by the user when assessing the client's suitability using the model selection service 225. It is with the information provided on this screen that the user performs step 620, viz., analyzing the information displayed and determining a more suitable recommendation.

The real-time multi-dimensional constraint status area 720 clearly and concisely visually indicates that the current recommendation is over-allocated to equities in general and large-cap stocks in particular. In the specific illustration, the current allocation to equities and large cap is 78% compared to a desired target of 55% and 39% respectively. Additionally, using the information displayed in the working solution area 740, the user is able to determine the investments that result in the over-allocation to large cap equities, the holdings IBM and the mutual fund T. Rowe Price Eq Idx 500. It should be obvious to persons practiced in the art that a remediation strategy could entail liquidating all or part of these over-allocated investments and distributing the liquidated dollar amounts across other asset categories. This is process step 640.

FIG. 8A is a screen shot of the portfolio construction user-interface when the user has selected the investment (IBM) from the current solution. The user has selected this particular investment by means of clicking on the row corresponding to this investment. At this point, the portfolio construction user-interface performs the following actions:

1. Visually communicate to the user the chosen investment. In the embodiment depicted, this achieved by highlighting the row in the working solution area corresponding to the specific investment.

2. Insert the selected investment and its attributes into the working investment area. In the illustration depicted, the attributes include the dollar value of the investment, its percent contribution to the overall portfolio and its underlying asset allocation.

FIG. 8B is a screen shot of the portfolio construction user-interface taken immediately after the user has liquidated the IBM investment in its entirety ($30,000). Of particular interest are the real time status indicator area 720 and more specifically the status indicators for Equities 760 and Large Cap 770. The user has been immediately notified about the consequences of the last action (i.e., liquidating IBM). In this specific illustration, the current allocations to both equities and large cap now read 48%. These new asset allocation values when compared against the target values immediately suggest that the liquidation of IBM is a step in the right direction, but not enough to meet the target. Specifically, while the large cap allocation has been brought closer to the target large cap allocation of 39%, the equity allocation is now under the target allocation percentage of 55%. Furthermore, area 780 displays the working capital available to the user for the purposes of reallocating amongst the target asset class allocations.

FIG. 8C is a screen shot of the portfolio construction user-interface taken after several iterations of the portfolio construction user work flow (FIG. 6). At this point, the user has liquidated several instruments such as IBM and T. Rowe Price Equity Index, and added new investments and allocations such as American Cash Management Fund and American Funds Growth Fund. The multi-dimensional constraint analysis status bar indicator displays the asset allocation of the current recommendation in relation to the target allocations. Clearly, the user has created a recommendation that is much more in line with the target allocation, compared to the original state (FIG. 7). Following the user work flow method described previously the user may continue to make further adjustments to achieve a recommendation status that satisfies the displayed constraints, or exit the recommendation construction by pressing the ‘Next Step’ button 715. According to one aspect of the present invention the system may be configured such that the user may be prevented from exiting the portfolio construction until a configured acceptable constraint status is attained. In an alternative configuration, the user may be provided with a warning message if he chooses to exit the portfolio construction activity when the constraint status is not acceptable.

Exemplary Real-Time Constraint Analysis Status Display Functionality

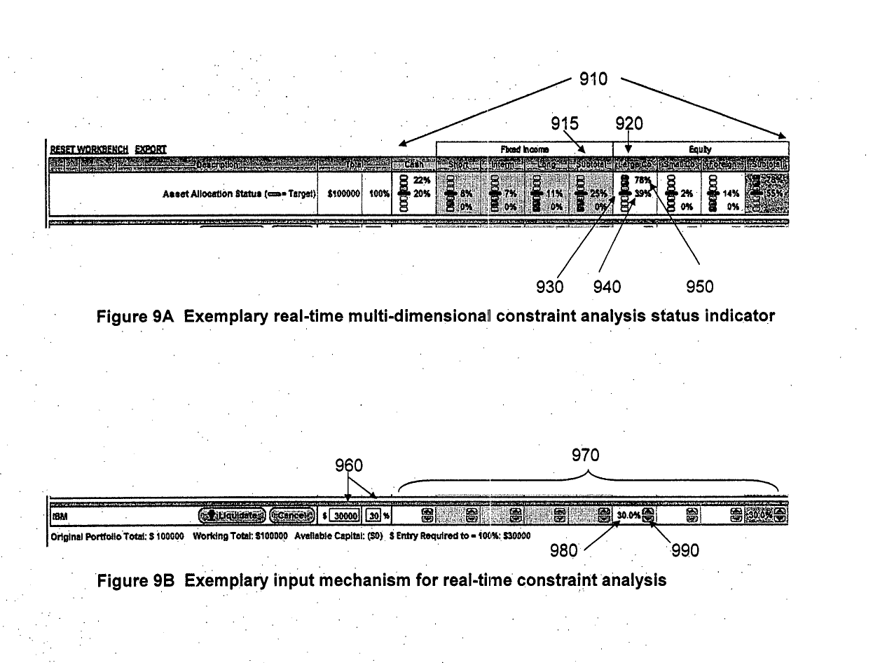

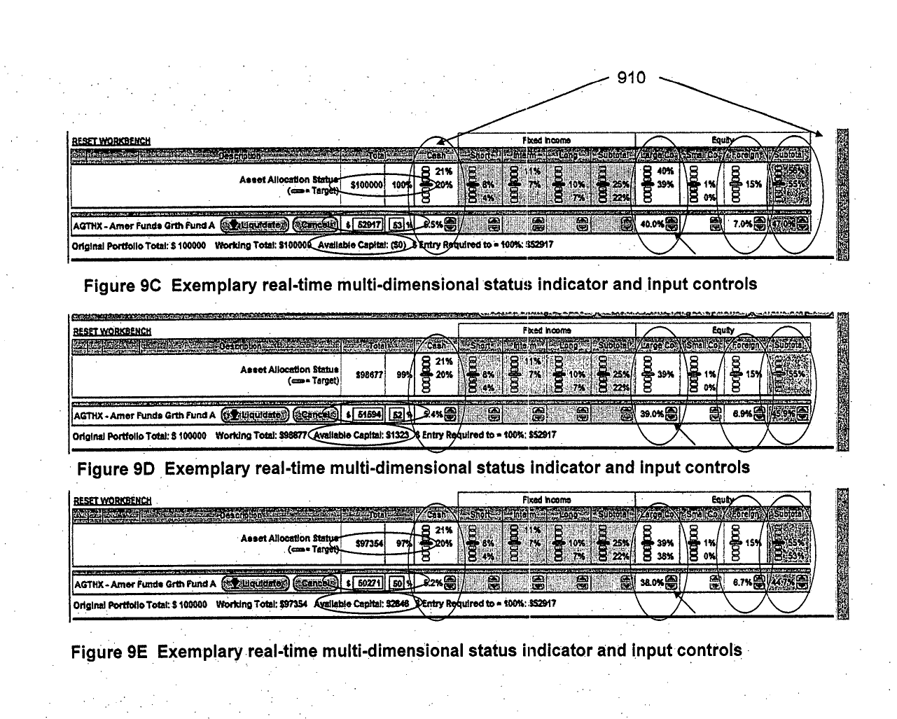

According to one embodiment of the present invention, status bars are the mechanism by which the multi-dimensional constraint analysis state 720 is presented back to the user. FIG. 9A depicts one such exemplary mechanism.

The overall constraint analysis status display 910 consists of a columnar series of status graphs, one for every constraint that needs to be addressed by the end user. An individual status graph 920 is designed to succinctly communicate to the user the current constraint state vis-à-vis its corresponding constraint target along with an indication of the measure of the deviation between the two. In the embodiment depicted, a constraint status bar comprises a horizontal “level” indicator 930 and a stack of horizontal deviation level indicators. Adjacent and immediately on the right of the level indicator is displayed the target attribute value 940. The current value of the attribute 950 is displayed either above or below the level indicator, depending upon its value in relation to the target. Furthermore, the measure of the deviation between the current allocation percent and the target allocation percent is presented to the user by means of a color gradient scheme. The use of a color gradient scheme visually depicts to the user the magnitude of the deviation for a specific constraint. Advantageously, when viewed amongst all the individual status indicators, the user is capable of prioritizing the order in which constraints may need to be addressed, as well as be able to converge upon a solution that complies with all targets.

Exemplary Real-Time Multi-dimensional Constraint Analysis Status Display Functionality

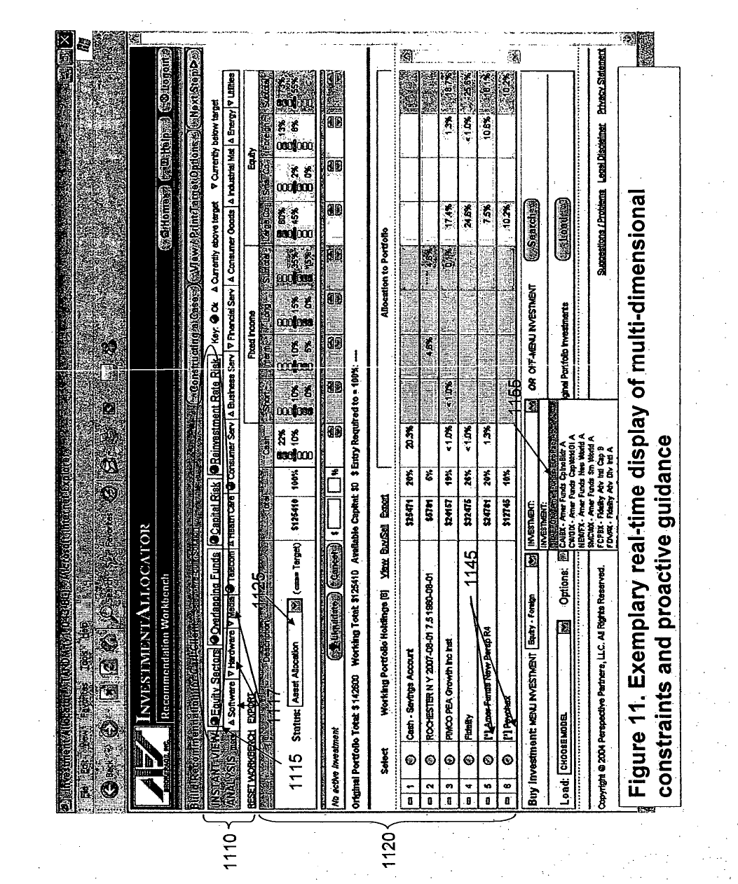

When a target recommendation comprises multiple objectives (such as asset allocation and sector allocation), the present invention provides a novel method of displaying the status of the working portfolio in relation to the plurality of configured (target) objectives. Specifically, it supports the user being able to select, view and manipulate an ‘active’ or ‘working’ objective, while simultaneously being informed about the status of the working portfolio in relation to the other configured objectives. This novelty is best understood by referring to FIG. 11, which is a screen shot of a configuration of the portfolio construction user interface which includes the real-time display of the status of the working portfolio in relation to a plurality of configured (target) objectives.

For the purposes of explanation, the following terminology will be used: a ‘working’ objective refers to an objective the user has selected, which in the embodiment illustrated is by means of a drop-down menu 1125. While the ‘working’ objective may be changed at will by the end-user, it defines the evaluative or analytical lenses through which the end-user prefers to see the working portfolio at any point in time. Changes may be made by modifying asset allocation characteristics, with implications and consequences for sector allocation, et. al. being viewable. Alternatively, when sector allocation is the user selected working objective, changes may be made by modifying sector allocation characteristics, with implications and consequences for asset allocation characteristics, et. al. being viewable.

According to the illustration depicted in FIG. 11, the user selected working objective is asset allocation. Thus, the main status indicator 1120 is similar to area 720 in FIG. 7. The main status indicator displays the state of the current recommendation in relation to asset allocation targets in the manner described previously. In addition, the user interface screen contains Instant Analysis View area 1110 which encapsulates and communicates the status of the working portfolio in relation to the other objectives that also need to be satisfied by the recommended portfolio. In the illustration depicted, these objectives are: Equity Sectors, Overlapping funds, Capital Risk and Reinvestment rate risk. Many others may be readily added, as one skilled in the art will recognize.

According to the illustration depicted, the Instant Analysis view status display of the non-active objectives includes a textual description of the objective, along with a visual representation 1115 of its status in relation to the configured target (off target, or level). In the embodiment illustrated, the status is visually presented to the user by means of a color coded ball icon. In a configuration of the present embodiment, the color red is used to signify a departure from target while the color green is used to signify the achievement of a target. According to the illustration depicted, the Equity Sectors, Capital Risk and Reinvestment Rate risk objectives are not on target, whereas the Overlapping funds objective has been achieved.

In addition to the method described to display the overall conformance/non-conformance of an objective to its target, the instant view status area may also contain individual indicators for the attributes that characterize the objective. In the illustration depicted, the constraint rules repository may contain individual targets for each equity sector in order to achieve the main Equity Sector objective. For example, these individual equity sector (target) attributes may be derived by analyzing the equity sector distribution of a model portfolio.

According to the embodiment depicted, the display of the objective's attributes comprises a textual display of the attribute and a visual indicator that communicates the status of the current recommendation in relation to the desired target. In the illustration depicted, each attribute has an associated off-target or level icon 1117. An “up” arrow is indicative that the current recommendation is above the target, and a “down” arrow is indicative that the current recommendation is below the target for the specific attribute. Thus, for the Equity Sector objective, the status indicators communicate that with respect to the current recommendation 740, the Software sector is over target, while the Hardware sector is below target. Similarly, the Media sector is under target while the Telecommunications sector is on target. The status of the remaining equity sectors may be interpreted in similar fashion.

Within area 1110, the user interface may further include a mechanism whereby the user may select a specific non-active objective whose attributes are immediately visible on the screen, such as the Equity Sector objective illustrated in FIG. 11. According to one embodiment, the non-active objectives are presented within the display area 1110 as “tabs”, whereby the user may select to view the attributes of a non-active objective by selecting the corresponding tab. For example, in an HTML user interface, such as the illustration shown, each displayed non-active objective label in area 1115 (i.e., Equity Sector, Overlapping Funds, Capital Risk and Reinvestment Risk) is a hyperlink which, when selected by the user, results in the user interface being redrawn with the attributes information of the selected non-active objective being displayed in area 1117. According to the embodiment depicted, if the user were to select the ‘Reinvestment Rate’ risk objective, area 1117 would display the attributes of this objective and the associated directionality status indicators discussed previously. Note that were this action to be performed, the working objective would still remain the Asset Allocation objective.

The user interface may also contain a mechanism for the user to toggle between the plurality of configured objectives that may be made the active objective, i.e., to be displayed and made manipulable in the area 1120. For example, at the time instant depicted in FIG. 11, the user may decide to switch from the Asset Class Gap objective to the Equity Sector objective. According to one embodiment, this functionality is provided by means of a drop-down box 1125 within the selected objective real-time status area 1120.

When configured in the manner illustrated, the user is able to see in real-time the consequences of a change to the recommendation not just to the actively selected objective, but also the impact it may have to the remaining configured objectives. For example, the user may be able to see the impact of the addition of a large cap equity investment not just to the asset allocation objective, and ensure that there are no implications to the equity sector diversification objective. Feedback that indicates over-allocation to a particular equity sector may be remedied quickly by substituting the newly added large-cap investment with a different equity sector characteristic. In this manner, the user is thus advantageously proactively informed whether the solution strategy contains adverse implications along the remaining dimensions that could, in the absence of such indicators, result in a less than ideal recommendation.

In another embodiment of the present invention, income needs constraints may be derived by using needs data generated using Needs Analysis module 220 and incorporated into the multi-dimensional constraint analysis module and depicted user-interface. When integrated with a data repository with income data for financial instruments in data layer 250, the income needs constraint is seamlessly integrated into the recommendation construction user-interface and the financial advisor is able to consider this constraint within the context of the other configured constraints.

Exemplary Input Manipulation

According to one embodiment of the present invention, the real-time multi-dimensional constraint analyzer supports both top-down and bottoms-up inputs by means of appropriate user interface input elements. The top-down functionality provides a means for the user to input a single component of a solution and receive feedback on its impact on the various dimensions of the constraint analysis. The purpose of the bottoms-up input mechanism is to allow the user to specify attributes of a solution component on a particular dimension (such as dollar amount), and receive feedback on the overall constraint analysis status, above and beyond the particular dimension for which a particular decision was made.

FIG. 9B depicts this novel bi-directional input mechanism within the context of a portfolio construction user interface. User-interface area 960 allows the user to specify a top-down input, specifically the contribution or allocation of an investment to a recommended portfolio. According to the preferred embodiment, the inputs may be specified either as a dollar contribution, or as a percent allocation. When a top-down input is supplied, the multi-dimensional constraint analyzer determines in real-time the impact of this contribution to the multiplicity of constraints. In the embodiment depicted, the analysis determines and relays back to the user in status area 910 the impact of the addition to both the individual target allocations, as well as the overall asset allocation.

Alternatively, in the bottoms-up modality, the user is able to specify the desired contribution of an investment to a specific asset class, and be informed in real-time the required allocation of this specific investment in relation to the overall recommendation. For example, the user may wish to explicitly set a specific asset allocation contribution of the selected investment. Alternatively, having allocated an initial dollar position and viewing its impact to a specific asset class, the user may desire to manipulate or adjust the asset class allocation in order to meet the target for that specific asset class. In both cases, the user is able to directly manipulate individual attributes and view in real-time the impact to the overall constraint analysis.

According to one embodiment of the present invention, a text field area 980 with an associated nudge bar 990 is the mechanism by which the described bottoms-up modality is delivered to the user. Referring again to FIG. 9B, area 970 provides individual text fields with an associated nudge bar, one for every asset class supported by the multi-dimensional constraint analyzer. These text fields and their corresponding nudge bars are determined to be either ‘active’ or ‘disabled’ by the multi-dimensional constraint analyzer depending upon the specific investment. In the figure depicted, IBM is a large cap equity, and thus only the Large Cap and [total] Equity text fields are active. On the other hand, a mutual fund with holdings that span the cash, large cap and foreign asset classes would have 4 active input controls—cash, large cap, foreign and [total] equity. A user may make a bottoms-up modification either by re-entering a value in a text field, or by direct manipulation of the nudge bar to increment or decrement the current value. For example, if the user desires to increase IBM's large cap allocation to 33%, he may either modify the existing value (30%), or use the “up arrow” in the associated nudge bar to arrive at this desired value. According to one embodiment of the present invention, the increment/decrement steps are a configurable start-up parameter in the financial advisory system described.

FIG. 9C is a screen shot of a section of the exemplary user interface that illustrates the output and input mechanisms for real-time multi-dimensional constraint analysis described where the real-time decision support novelty of the present invention may be appreciated. By juxtaposing the real-time constraint analysis results, and the input area in the manner shown, the user is able to focus on iteratively building a solution that satisfies the multiple constraints. In the illustration shown, the user may receive real-time feedback on the status of the constraints when he performs any one of the following actions:

1. Top-down

a. Modify the dollar position of the current investment (AGTHX) b. Modify the percentage of the current investment in the portfolio

2. Bottom-up

a. Modify the allocation of AGTHX to any of the ‘active’ asset classes, specifically, Cash, Large Cap, Foreign and Equity sub total b. Use the nudge bar associated with any of the ‘active’ asset classes. For example, in order to bring the overall Cash allocation down from 21% to the target of 20%, the user may choose to use the down arrow nudge bar associate with the Cash allocation

FIGS. 9D and 9E depict the same user-interface area as 9C through two additional “bottoms up” iterations of the recommendation construction process using the exemplary input manipulation controls and real-time status indicator display. In the depicted illustration, the user has chosen the mutual fund AGTHX as a recommended investment. The underlying asset allocation of this fund, retrieved from the data layer 250, spans 3 of the configured asset classes—Cash, Large Company and Foreign.

As may be seen in FIG. 9D, the user has used the nudge bar control 990 to decrement the large cap allocation of the currently selected investment AGTHX by clicking on the “down” arrow associated with the nudge bar input control. In the depicted embodiment, the increment/decrement parameter is configured to 1%, but may be configured for other increment/decrement values. For example, the dollar allocation text field 960 may be configured to include nudge bars with an increment/decrement value of $50. In accordance with the steps 515, 520, 530 and 540 described in FIG. 5 the user-initiated decrement is instantaneously detected by the user-interface and the impact of this decrement is analyzed by the constraint analyzer along all configured dimensions and communicated back to the user in the constraint analyzer status area. Furthermore, real-time updates are applied to all impacted input fields in area 970. Note that a decrement of the large cap contribution of the depicted mutual fund AGTHX would in general proportionately decrement allocations to all the asset classes associated with the fund, as well as the dollar allocation (and its corresponding fractional allocation).

With respect to the real-time indicator status area 910, the large cap allocation column display indicates that the overall large cap allocation of the recommendation has aligned with the target (39%). Likewise, the foreign asset class allocation has decremented to 6.9%, which together bring the overall Equity allocation status display in line with the target (55%). The cash allocation has dropped to 5.4%

Correspondingly, the dollar amount in the recommended portfolio drops from $52917 (53% portfolio allocation) to $51594 (52% portfolio allocation). In addition, the Available capital field is updated to indicate that by decrementing the amount of the mutual fund in the recommended portfolio, the user needs to allocate an additional $1323 to reach a total recommended portfolio value of $100,000.

FIG. 9E depicts the same user-interface screen area when the user has decremented the Large cap allocation of AGTHX by an additional percentage point. In addition to the real-time status indicators which reveal an under-allocation to the large cap and equity asset classes, the portfolio level fields are dynamically updated to reflect the reduced allocation (both on a dollar and portfolio percentage basis) to the selected mutual fund and, compared to 9D, a further increase in working capital. ($2648).

Given the novel design of the user-interface, it should be obvious that decrementing the large cap allocation user interface elements is not the only means by which the user may arrive at 9D from 9C, or 9E from 9D. For example, at 9D, the user may instead choose to decrement the Equity sub-total allocation from 45.9% to 44.7%. Were this action performed, the real-time constraint analysis would yield output values that would result in the identical state of the user-interface area as has been previously described.

Exemplary Pro-Active Guidance Using Real-Time Multi-Dimensional Constraint in Portfolio Construction

In addition to visually relaying the impact of any change to an attribute in the working solution, the multi-dimensional constraint analysis module may also pro-actively guide the user in arriving at a solution that addresses the multiple objectives in the constraint rules repository 350 by analyzing the recommendation in relation to the objectives, and using guidance rules 370.

The guidance provided may be with respect to the liquidation of existing investments as well as the choice of investments to be used to create a recommendation. In addition, the guidance that is provided may be suggestive or forced. When providing suggestive guidance, the constraint analyzer provides hints or directions that the end user may choose to incorporate into a subsequent iteration of the recommendation construction process. When forced guidance is provided, the end-user must incorporate the guidance provided into the recommendation construction process.

In one embodiment of the present invention, proactive guidance checks may be performed first in step 510, when the user has first invoked the portfolio construction user-interface and subsequently in step 540 when real-time inputs are received and processed by the constraint analyzer.

According to one embodiment of the present invention, the multi-dimensional constraint module provides hard guidance by constraining product recommendations based upon the client's suitability profile which may include time horizon, tolerance to risk and tax sensitivity parameters. The filtered product shelf is provided to the portfolio construction service which populates the input elements in the ‘Buy Investment Input’ area 755.

In another embodiment of the present invention, the real-time multi-dimensional constraint module additionally constrains product selection choices based on the advisor's licensing status. The advisor licensing status may be stored in the Advisor data repository in Data Layer 250.

By way of illustration of a advisor licensing based constraint configuration: a Series 6 licensed advisor may only be provided access to mutual fund investments in the product shelf. Alternatively, a Series 7 licensed advisor may be provided access to individual stocks and fixed income investments, as well as products that are “Off shelf”, or not pre-screened for compliance criteria.

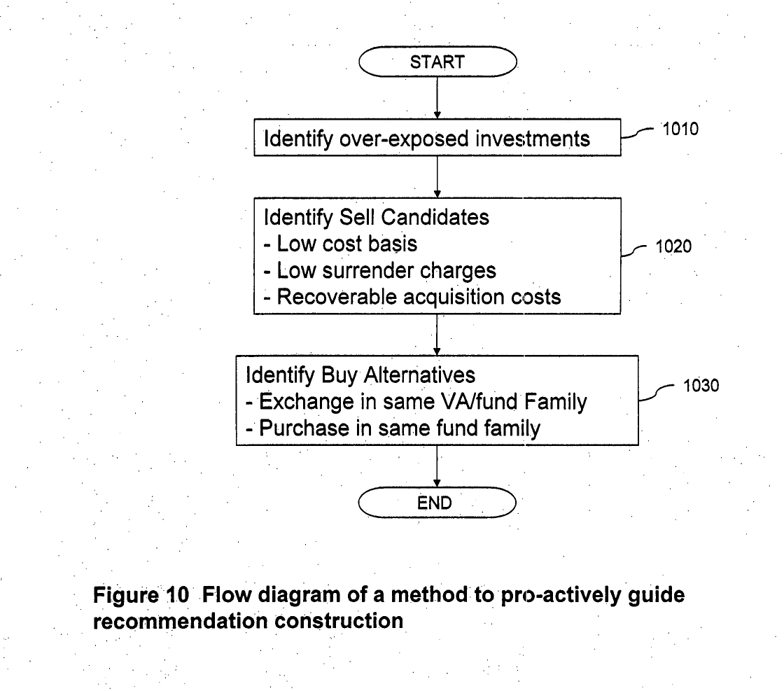

FIG. 10 is a flow diagram illustrating a method to provide pro-active guidance to the liquidation of assets in a portfolio and suitable alternatives in order to satisfy multiple constraints such as a desired asset allocation target constrained by purchase cost considerations, client tax sensitivity, and advisor licensing status.

At step 1010 asset allocation analytics are retrieved from system memory cache or from disk using keys that identify the specific financial advisor, the client, the portfolio, etc. for whom the recommendation is being constructed. Alternatively, the asset allocation constraint analysis may be re-run. Investments in the portfolio that contribute to over-allocation are identified. The pre-configured rules may specify a priority order to these over-exposed investments. For example, individual securities in the client's portfolio may be given priority over mutual funds.

At step 1020, the constraint analyzer uses pre-configured rules and market data elements to identify and tag those over-exposed investments identified in the previous step that are candidates for liquidation. In one embodiment, the rules applied relate to cost basis, surrender charges and recoverable acquisition costs. These data elements are retrieved from the appropriate client portfolio data repositories located in Data Layer 250.

At step 1030, appropriate replacement investments are identified by querying a product repository using configured product constraint rules. In one embodiment, the ‘buy’ side constraint rules specify candidates as potential exchanges in the same fund family, or for net new purchases, purchases within the same fund family. The identified ‘Sell’ and ‘Buy’ investments are communicated to the portfolio construction service 235. Using this tagged basket of ‘Sell’ and ‘Buy’ investments, the user-interface may be rendered with distinct ‘Sell’ and ‘Buy’ visual icons that are placed adjacent to the appropriate investments in the displayed portfolio construction user interface Alternatively, for the Buy side investments, the user-interface may display product only those product shelf candidates that meet the pre-configured buy side constraint requirements.

The Buy Investment area of FIG. 11 is an illustration of a user interface which may incorporate the proactive investment liquidation and replacement investment guidance described above. Two investments in the current recommendation—American Funds New Perspectives and PayChex—have been identified by the pre-configured guidance rules as sell investments and contain a visual marker (the ‘[*]’) 1145 to inform the end-user. Likewise, the drop-down box 1155 contains a product shelf investment American Funds EuroPac A that is a suitable buy side investment. As explained above, in this embodiment this particular pro-active guidance is configured to be suggestive, and not forced.

Exemplary Investment Recommendation Logging Functionality and Investment Recommendation Monitoring User Interface

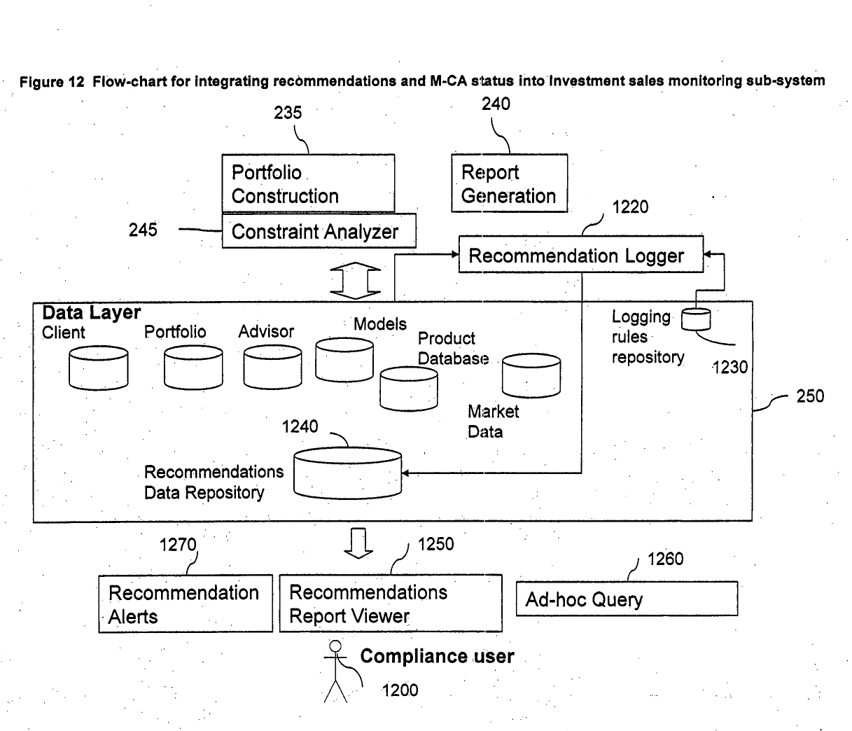

FIG. 12 is an illustration of the data flow of an embodiment of an investment recommendation logging module 1220 that may support a Compliance user 1200 work function integrated with the exemplary Financial Advisory system 200 previously described. Example work flow activities, supported by software services are: Recommendations Report Viewer 1250, Ad hoc Query 1260 and Recommendation Alerts 1270 described in the next section.

The purpose of the recommendation logging module 1220 is to extract and store data elements from the portfolio construction activities in a manner and format that facilitates both the archival and pro-active monitoring of recommendation activities as required to support a configured compliance function.

The recommendation logging rules repository 1230 is a collection of business rules that specifies the elements and attributes of the recommendation repository, including data formatting, storage format, and rules specifying recommendations that may be flagged or marked for review by a compliance user. The rules governing the inclusion/exclusion of recommendations for compliance review may include attributes from the constraint rules repository and measures of deviation of the recommendation from a target. For example, a recommendation that contains a deviation of greater than 10% from any target asset class may be pre-configured to be marked for review. In addition, the repository may include user-interface event detection rules such as for example, if the user selects the “off shelf” product link.

According to the embodiment depicted, the data that is logged may be harnessed from the modules used to support the financial advisor's portfolio construction and report generation activities 235, 245 and 240 as well as other data repositories in the data layer 250.

According to one embodiment, this captured data may be stored in a separate data repository within the data layer 250. In another embodiment, the data may be stored in computer memory to optimize system response time.

Exemplary Investment Recommendation Monitoring Functionality for Compliance User

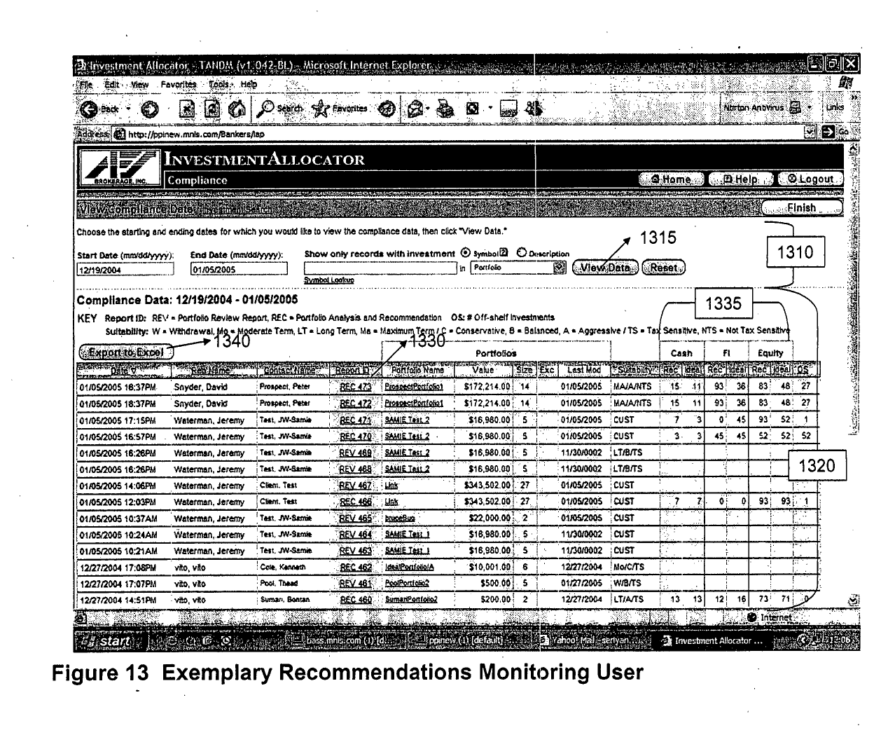

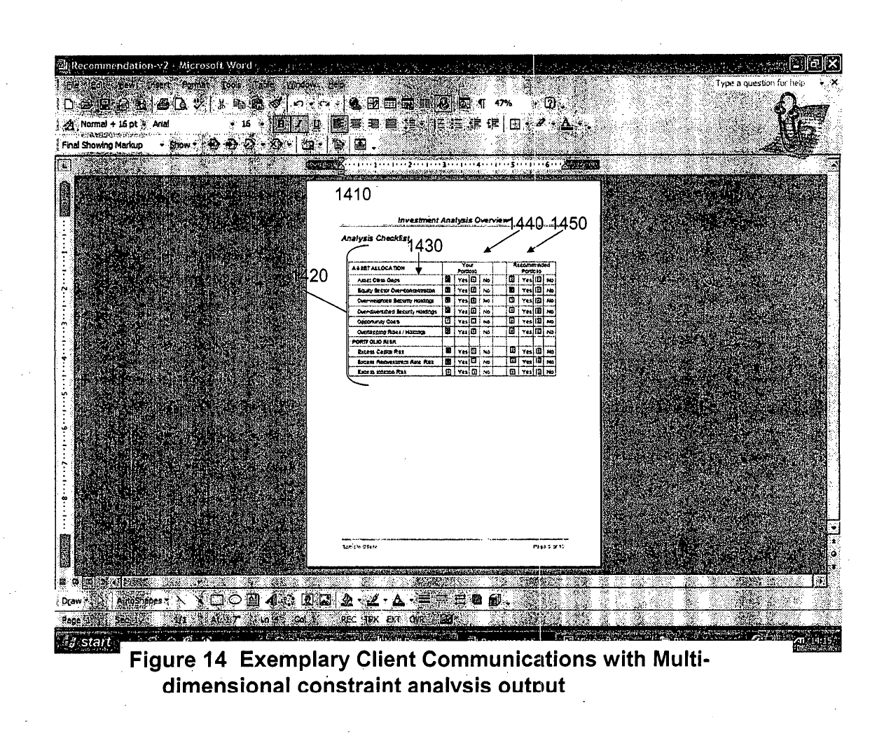

FIG. 13 is an illustration of a Compliance user's screen that may be supported by a financial advisory system that incorporates the logging and archival of portfolio construction with the multi-dimensional constraint analyzer. The user interface shows an embodiment of the Recommendation report viewer 1250 and Recommendation Ad Hoc querying 1260 that is supported by the recommendation logging method described in the previous section. The Compliance user 1200 accesses this user interface to search for and review recommendations that have been created by financial advisors.

As depicted, the user interface may include two distinct areas—area 1310 supports ad hoc querying and area 1320 supports the Report viewing functionality. In another embodiment the same functionality may be provided by means of individual user interface screens, one for report viewing, and one for ad hoc querying.

Ad hoc querying area 1310 allows the user to specify selection criterion for retrieval of recommendation activity data from the recommendation logging repository 1240. Selection criterion may include dates and date ranges, recommendations with specific investments and optionally, within specific client portfolios. After specifying a search criterion, the desired data may be retrieved by pressing the ‘View Data’ button 1315. When the ‘View Data’ event is detected, the Ad Hoc Querying service 1260 retrieves the data from recommendations data repository 1240 and displays the data in report viewing area 1320.

Report viewing area 1320 may include recommendation activity data displayed by means of a tabular format where a row represents a single recommendation activity event and columns representing attributes of the recommendation activity. Attributes may include time/date information, financial advisor information, client personal information, client portfolio information, client suitability information, product related data and multi-constraint analysis data. The format and order of the display is specified in logging rules repository 1230. The information displayed in a column may be text, graphics, numerical data or hyperlinks. Hyperlinks provide a means for the user to access supplementary or more detailed information. In the embodiment depicted, the Reportld column 1330 contains hyperlinks which, when selected by the user will retrieve and render the client-ready communication created by the financial advisor. Likewise, the Portfolio Name column 1331 contains a hyperlink to the client's original portfolio.

The display of multi-constraint analysis data elements associated with each recommendation is a means by which the compliance user may quickly determine the appropriateness of a recommendation to the specific client. In one embodiment, the multi-constraint analysis data is localized to a specific area, the Report Viewer screen area 1320. In this same embodiment, area 1335 displays the target and actual allocations for each asset class juxtaposed next to each other.

The Report viewer may include a mechanism for the user to export or download the on-screen recommendation logging data into another computer system or program. In the embodiment depicted, selecting link 1340 initiates a process by which the user may download the recommendation activity data to their personal computer. This process may include retrieving the online data and formatting it for compatibility with external systems/programs. Once downloaded, the user may import the data into another computer program such as Microsoft Excel.

The ad hoc querying service 1260 may be configured with a default search criterion which may be used to display an initial report. As depicted, the default search criterion and therefore the default report view is a 2 week date range, where the end date is the current date.

Within the framework of the financial advisory system 200 discussed, the Recommendations data repository 1240 may be integrated with access control service 205. Thus, Compliance user 1200 may only be able to search on, and review the portion of the recommendation data repository he has access to. For example, the compliance user may only have access to the recommendation activities of the financial advisors in a specific geographic location. Likewise, a compliance manager may have access to the recommendation activities of a set of geographic locations.

The Recommendation logger module 1220 may be configured to provide a pro-active recommendation alerts service 1270 for the compliance user. Using logging rules repository 1230, the logger module determines whether a recommendation violates one or more of the compliance alert rules. Non-compliant recommendations are flagged and disseminated to the appropriate compliance user. The contents and format of the alerts may also be specified in logging rules repository 1230.

Alerts may be disseminated via any of a number of communication media such as email, instant messaging and telephone. In one embodiment, alerts are sent in real-time. In another embodiment, alerts are dispatched on a configurable, periodic basis, such as nightly or weekly.

Exemplary Client Communications with Multi-Dimensional Constraint Analysis

FIG. 14 is a screen-shot of an electronic, print-ready page of a formal client communication document (‘Recommendation Report’) created by Report Generation service 240 that may contain a recommendation constructed by financial advisor 201 using the portfolio construction service 235 that has been integrated with the real-time multi-dimensional constraint analyzer 240.

According to the embodiment depicted, the client communication contains an Analysis Summary page 1410 which contains a summary of the multi-dimensional constraint analysis in relation to the client's current portfolio and the recommended portfolio. The summary is presented by means of a table 1420 containing the multiple objectives the financial advisor attempted to achieve, and an indicator of the measure of success in achieving that objective. According to the embodiment depicted, each objective is listed with a textual description of the objective 1430 and the state of the objective in relation to the client's original portfolio 1440 and the recommended portfolio 1450. The measure of achievement of a particular objective is communicated to the reader by the appropriate marking of one of two adjacent check-boxes with associated text labels “Yes” and “No”. Furthermore, the success measure may use a color gradient to provide an additional visual indicator to the reader. According to the embodiment depicted, the color green is used to visually represent ‘Yes’, and the color red to visually represent ‘No’. In the particular illustration depicted, it is immediately clear to the reader that the advisor has created a recommendation that addresses all but one concern, specifically over-diversification amongst equity sectors. Subsequent pages in the document may contain additional detail of the analysis. Regardless of the manner in which the analysis is presented, the client is able to make a more informed investment decision when presented with a manifest of the multiple objectives and the capability of the recommendation to address the objective.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. An automated method of managing a portfolio comprising at least one financial instrument, and wherein the portfolio is defined by computable portfolio attributes, the method comprising a user using a system comprising a processor and at least one client machine that includes a display and an input device, the method comprising:
defining at least one objective representing a desired state for the portfolio attributes;
defining a set of constraints in relation to a computable, desired state of portfolio attributes in relation to the at least one objective;
providing a constraints analysis module to the processor;
providing the constraints to the constraints analysis module;
evaluating the portfolio with the processor using the constraints analysis module;
displaying the state of the portfolio attributes based upon the evaluation; and
simultaneously displaying at least one alternative financial instrument for altering portfolio attributes in order to more effectively meet the objective, the alternative financial instrument being displayed with an interactive user input mechanism that allows for selection of an alternative financial instrument and automatic evaluation and display of the state of the portfolio attributes due to selection of the alternative financial instrument.

2. A method in accordance with claim 1 wherein the at least one alternative financial instrument is displayed in line with at least one attribute that is impacted.

3. A method in accordance with claim 1 wherein the interactive user input allows for manipulation of the at least one alternative financial instrument and the method further comprises displaying the impact of the manipulation on at least one attribute.

4. A method in accordance with claim 3 wherein the at least one alternative financial instrument is a specific financial instrument and the manipulation represents one of an amount or a percentage of the portfolio to allocate to the specific financial instrument.

5. A method in accordance with claim 1 wherein the interactive user input allows for manipulation of at least one attribute and the method further comprises displaying the impact of the manipulation of the attribute on at least one other attribute.

6. A method in accordance with claim 1 wherein the results of the evaluation are displayed with visual indicators relating to the objective that illustrate a current state for portfolio attributes, a target state for the portfolio attributes based upon the objective and a deviation measure.

7. A method in accordance with claim 6 wherein there are multiple objectives defined and wherein the results of the evaluation are displayed with visual indicators relating to a working objective that illustrate a current state for portfolio attributes, a target state for the portfolio attributes based upon the working objective and a deviation measure, and the results are further displayed with secondary visual indicators that provide at least one of status information and directionality information with regard to attributes relating to a non-working objective.

8. A method in accordance with claim 1 wherein a plurality of alternative financial instruments is displayed.

9. A method in accordance with claim 8 wherein at least one of the alternative financial instruments is indicated as a recommended alternative financial instrument.

10. A method in accordance with claim 9 wherein the recommended alternative financial instrument is a required alternative financial instrument.

11. A method in accordance with claim 8 wherein the plurality of alternative financial instruments is displayed in a pull down menu.

12. A method in accordance with claim 11 wherein the plurality of alternative financial instruments is displayed in a series of pull down menus.

13. A method in accordance with claim 12 wherein the plurality of financial instruments displayed are determined at least in part according to advisor licensing status.

14. A method in accordance with claim 1 where the processor is resident on the client machine.

15. A method in accordance with claim 1 wherein the system comprises a central server that includes the processor and the method further comprises storing the state of the portfolio attributes on the central server.

16. A method in accordance with claim 15 further comprising accessing the central server with a second client machine.

17. A method in accordance with claim 15 further comprising flagging portions of the state of the portfolio attributes that deviate from the constraints for compliance review.

18. A method in accordance with claim 17 further comprising notifying a compliance review user when portions of the state of the portfolio attributes have been flagged.

19. A method in accordance with claim 15 further comprising providing access to at least one attribute of the stored portfolio attributes to a second user.

20. A method in accordance with claim 15 further comprising accessing the central server to generate a client report relating to the state of the portfolio attributes and forwarding the report to a client.

21. An automated method of evaluating a portfolio comprising at least one financial instrument and wherein the portfolio is defined by computable portfolio attributes, the method using a system comprising a processor and at least one client machine that includes a display and an input device, and the system uses a constraints analysis module that defines constraints as computable constraint attributes for achieving at least one objective within the portfolio, the method comprising:
displaying information relating to a specific financial instrument that should be one of added to or deleted from the portfolio;
displaying at least one indicator adjacent to the specific financial instrument that indicates status of at least one attribute impacted by the specific financial instrument;
supplying attribute information to the processor through an interactive input mechanism relating to the at least one attribute; and
altering the at least one indicator and the interactive input mechanism in real-time as a result of the supplied attribute information.

22. A method in accordance with claim 21 wherein the attribute information is related to at least one constraint attribute.

23. A method in accordance with claim 21 wherein the attribute information is related at least one portfolio attribute.

24. A method in accordance with claim 23 wherein at least one portfolio attribute is related to a specific allocation of the portfolio to the specific financial instrument.

25. A method in accordance with claim 21 wherein multiple objectives are defined and wherein the indicators comprise visual indicators related to a working objective that illustrate a current state for portfolio attributes, a target state for portfolio attributes based upon the working objective and a deviation measure, and visual indicators related to at least one non-working objective that provide at least one of status information and directionality information with regard to attributes relating to the non-working objective.

26. A system for managing a portfolio comprising at least one financial instrument and wherein the portfolio is defined by computable portfolio attributes, the system comprising:
a processor;
a display in communication with the processor;
an input device in communication with the processor;
a constraints analysis module that includes a set of constraints that are defined in relation to a computable, desired state of portfolio attributes in relation to at least one objective representing a desired state for the portfolio attributes;
at least one indicator viewable on the display that indicates the state of at least one portfolio attribute relative to a constraint attribute; and
an interactive input mechanism viewable on the display that allows for manipulation of a specific financial instrument and related attribute information in order to alter portfolio attributes;
wherein the processor automatically updates the indicator and the interactive input mechanism in response to any manipulation of the specific financial instrument and any manipulation of the attribute information.

27. A system in accordance with claim 26 wherein the interactive input mechanism is adjacent to the indicator on the display.

28. A system in accordance with claim 26 wherein the processor and the constraints analysis module are located on a central server.

29. A system in accordance with claim 26 further comprising a data storage module that stores the portfolio, the processor and the data storage module being located on a central server.

30. A system in accordance with claim 29 wherein the constraints analysis module is located on the central server.

31. A system in accordance with claim 26 wherein the system is HTML based.

32. A system in accordance with claim 26 wherein the system is Java based.

33. A system in accordance with claim 26 wherein the indicator is a directional indicator indicating a direction of needed manipulation of the portfolio attribute.

34. An automated method of constructing a portfolio comprising at least one financial instrument, the method comprising:
determining a set of computable constraints for constructing the portfolio, the constraints being defined by analytic characteristics or attributes of the portfolio and its financial instruments;
providing a constraints analysis module to a processor;
providing the set of computable constraints to the constraints analysis module;
evaluating the portfolio with the processor using the constraints analysis module to thereby determine if the portfolio and its financial instruments satisfies or violates any of the constraints;
displaying information to a user regarding the results of the evaluation of the portfolio;
simultaneously displaying alternative financial instruments for altering the portfolio that address violations of the set of constraints within the information; and
selecting an alternative financial instrument to alter the portfolio;
wherein, upon selecting an alternative financial instrument for altering the portfolio, the portfolio is further evaluated by the processor using the constraints analysis module to thereby determine if the portfolio and its financial instruments satisfies or violates any of the constraints, and wherein information and alternative financial instruments for altering the portfolio, if needed, are simultaneously displayed regarding the results of the further evaluation of the portfolio.

35. An automated method in accordance with claim 34 wherein the set of constraints is provided to the processor on a portable computer readable medium.

36. An automated method in accordance with claim 34 wherein the set of constraints is provided to the processor such that it is resident on the processor in memory.

37. An automated method in accordance with claim 34 wherein the information is displayed with visual indicators to indicate whether or not a constraint has been met.

38. An automated method in accordance with claim 37 wherein the indicators use color coding to indicate the degree to which a constraint has been met.

39. An automated method in accordance with claim 38 wherein the indicators comprise a green indicator for compliance with a constraint and a red indicator for noncompliance with a constraint.

40. An automated method in accordance with claim 34 wherein the set of computable constraints are based upon multiple objectives.

41. An automated method in accordance with claim 40 wherein each objective comprises one of a group comprising asset allocation, instrument diversification, equity sector diversification, fund manager role in fund investment, mutual fund holdings overlap, management fees for mutual funds or other managed products, portfolio risk objectives, capital accumulation or growth and income distribution objectives.

42. An automated method in accordance with claim 40 wherein there is an interactive user input mechanism for selecting any one of the objectives to be a current working objective.

43. An automated method in accordance with claim 42 wherein the interface mechanism is a drop-down menu.

44. An automated method in accordance with claim 41 wherein one of the objectives comprises asset allocation and a target asset allocation is defined for the objective that is configured based upon at least one of client risk tolerance, client time horizon and client tax sensitivity status.

45. An automated method of constructing a target portfolio comprising at least one financial instrument, the method comprising:
providing an initial portfolio comprising at least one financial instrument;
determining a set of computable constraints for constructing the target portfolio, the constraints being defined by analytic characteristics or attributes of the target portfolio and its financial instruments;
providing a constraints analysis module to a processor;
providing the set of constraints to the constraints analysis module;
evaluating the initial portfolio with the processor using the constraints analysis module to thereby determine if the initial portfolio and its financial instruments satisfies or violates any of the constraints;
displaying information to a user based upon the results of the evaluation of the initial portfolio;
simultaneously displaying alternative financial instruments for altering the initial portfolio that address violations of the set of constraints within the information;
selecting an alternative financial instrument to alter the initial portfolio, wherein upon selecting an alternative financial instrument for altering the initial portfolio, the resulting portfolio is automatically further evaluated by the processor using the constraints analysis module to thereby determine if the resulting portfolio and its financial instruments satisfies or violates any of the constraints, and wherein information and alternative financial instruments for altering the portfolio, if needed, are automatically simultaneously displayed based upon the results of the further evaluation of the portfolio;
completing the target portfolio once the user is satisfied that the constraints have been satisfactorily met, and
storing the target portfolio and constraints attributes.
